(19) United States
(12) Patent Application Publication
(10) Pub. No.: US 2026/0343642 A1
(43) Pub. Date: Oct. 29, 2026

(54) Communications Systems with Peer-to-Peer Regulatory Signaling

(71) Applicant: Apple Inc., Cupertino, CA (US)

(72) Inventors: Ahmad Reza Hedayat, Carlsbad, CA (US); Hassan Yaghoobi, San Jose, CA (US); Yong Liu, Campbell, CA (US); Abhishek Rala, Campbell, CA (US); Yanjun Sun, San Diego, CA (US)

(21) Appl. No.: 19/647,707

(22) Filed: Apr. 14, 2026

Related U.S. Application Data
(60) Provisional application No. 63/795,993, filed on Apr. 28, 2025.

(51) Int. Cl. H04W 76/14; H04W 4/021; H04W 8/00; H04W 52/36; H04W 60/04

(52) U.S. Cl. CPC H04W 76/14; H04W 4/021; H04W 8/005; H04W 52/367; H04W 60/04

(57) ABSTRACT

A communication system is provided in which access points (APs) communicate with stations (STAs) (e.g., under an 802.11 protocol). The STAs may receive enabling signals transmitted by APs. The STAs may be enabled by APs from which the STAs received the enabling signals with at least a threshold signal level. A first STA may establish a peer-to-peer (P2P) link with a second STA. The first and second STAs may convey frames over the P2P link that include Extended Regulatory Information Elements. An Extended Regulatory Information Element may include at least a control field and an observed enabling AP list. The control field may include a Modes field, presence bits and/or an enabling AP count field. The list may include a set of segments each indicating a respective enabling AP of the transmitting STA. Each segment may include a channel number, BSSID, SSID, and/or SMDID fields.

This application claims the benefit of U.S. Provisional Patent Application No. 63/795,993, filed Apr. 28, 2025, which is hereby incorporated by reference herein in its entirety.

### FIELD

This disclosure relates generally to wireless communications, including wireless communications by electronic devices.

### BACKGROUND

Communications systems and methods are used to convey wireless data between nodes of a communications network. The nodes can include user equipment devices, wireless access points, wireless base stations, or other electronic devices.

It can be challenging to ensure that communications systems exhibit sufficient levels of performance. If care is not taken, communication between nodes of a communications network can exhibit excessive latency or can consume excessive resources.

### SUMMARY

A communication system such as an Infrastructure BSS wireless communication system is provided in which access points (APs) communicate with stations (STAs) (e.g., under an 802.11 protocol). A peer-to-peer (P2P) wireless communications system is a system in which STAs communicate directly with each other without communication passing through an AP. The STAs may receive enabling signals transmitted by APs as a way to enable the STAs to perform direct communications (e.g., for supporting regulatory requirements). The STAs may be enabled by APs from which the STAs received the enabling signals with at least a threshold signal level. A first STA may establish a P2P link with a second STA. The first and second STAs may convey frames over the P2P link that include Extended Regulatory Information Elements. Examples of P2P links include client-to-client (C2C) or Very Low Power (VLP) links for applications in a 6 GHz band.

An Extended Regulatory Information Element may include at least a control field and an observed enabling AP list. The control field includes a Modes field, an optional basic service set identifier (BSSID) present bit, an optional Service Set Identifier (SSID) present bit, an optional Seamless Mobility Domain Identifier present bit, and an enabling AP count field. The observed enabling AP list may include a set of segments each indicating a respective enabling AP of the transmitting STA. Each segment may include a channel number field, a BSSID field, a SSID field, and/or an SMDID field associated with its corresponding enabling AP. The STAs may use the Extended Regulatory Information Elements to improve backward compatibility between P2P devices, and/or to increase wireless performance and/or efficiency for subsequent P2P and/or AP-client communications. Multiple sets of control and observed AP lists may be utilized for advanced use cases if desired.

### BRIEF DESCRIPTION OF THE DRAWINGS

FIG. 1 is a diagram of an illustrative wireless communications system in accordance with some embodiments.

FIG. 2 is a schematic diagram of an illustrative wireless station (STA) in accordance with some embodiments.

FIG. 3 is a schematic diagram of an illustrative wireless access point (AP) in accordance with some embodiments.

FIGS. 4, 5A, and 5B are diagrams of illustrative network deployments that include multiple access points and multiple STAs that perform peer-to-peer signaling in accordance with some embodiments.

FIG. 6 is a flow chart of illustrative operations that may be performed by STAs to communicate with a network and with each other over a peer-to-peer link in accordance with some embodiments.

FIG. 7 is a diagram of an illustrative Extended Regulatory Information Element that may be conveyed between STAs in accordance with some embodiments.

FIG. 8 is a diagram of an illustrative transmit power envelope information element that may be conveyed between STAs in accordance with some embodiments.

FIG. 9 is a diagram of an illustrative neighbor awareness networking (NAN) frame that may be conveyed between STAs and that may include an Extended Regulatory Information Element in accordance with some embodiments.

FIG. 10 illustrates an example of a wireless communications system that includes Infra Basic Service Set and peer-to-peer networks in accordance with some embodiments.

### DETAILED DESCRIPTION

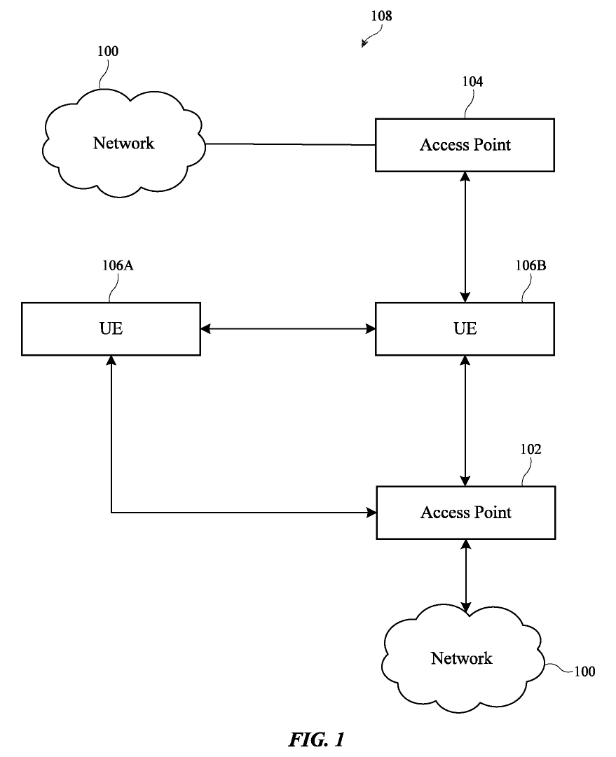

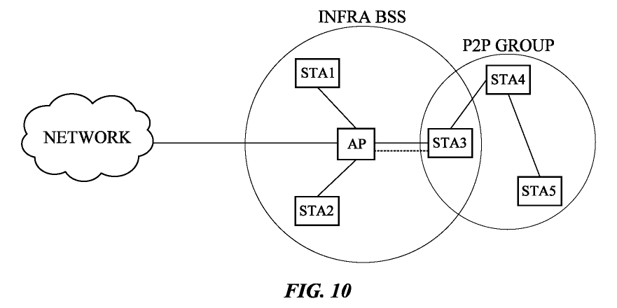

FIG. 1 illustrates an example of a wireless communication system 108 (sometimes also referred to herein as wireless communications network 108, communications network 108, network 108, or system 108). It is noted that FIG. 1 represents one possibility among many, and that features of the present disclosure may be implemented in any of various systems, as desired. For example, embodiments described herein may be implemented in any type of wireless device. The wireless embodiment described below is one example embodiment. In some more specific implementations that are described herein, wireless communication system 108 may include an Infra Basic Service Set (Infra-BSS) system and a corresponding peer-to-peer (P2P) group (see, e.g., FIG. 10 and the corresponding description below).

As shown in FIG. 1, the exemplary wireless communication system 108 includes an access point (AP) 104, which communicates over a transmission medium with one or more wireless devices 106 (e.g., a first wireless device 106A, a second wireless device 106B, etc.). Wireless devices 106A and 106B may be user devices (e.g., user equipment (UE) devices), such as stations (STAs), non-AP STAs, or wireless local area network (WLAN) devices. Wireless devices 106 are sometimes referred to herein as STAs 106, clients 106, or non-AP STAs 106. In implementations where wireless communication system 108 includes an Infra-BSS network and a P2P group/network, a STA may, if desired, communicate or listen to another network (e.g., in a P2P group) while also communicating with its own network (e.g., an Infra-BSS). More generally, a STA communicating in a P2P group may also communicate with an Infra-BSS or may, if desired, only listen to an AP in the Infra-BSS without communicating with the AP.

STA 106 may be a device with wireless network connectivity such as a mobile (e.g., cellular) telephone, a hand-held device, a wearable device (e.g., a wristwatch device, pendant device, ring device, head-mounted device such as a virtual, mixed, and/or augmented reality headset, goggles, helmet, or glasses, etc.), a computer (e.g., a desktop computer, laptop computer, a computer monitor containing an embedded computer, etc.), a tablet computer, a media player, headphones, one or two wireless earbuds, a television, a gaming device or console, a navigation device, an embedded system such as a system in which electronic equipment with a display is mounted in a kiosk or automobile, a wireless internet-connected voice-controlled speaker, a home entertainment device, a remote control device, a gaming controller, a user input device, peripheral, or accessory, an electronic stylus or pen, an unmanned aerial vehicle (UAV), an unmanned aerial controller (UAC), an automobile, computing equipment integrated into a vehicle or kiosk, equipment that implements the functionality of two or more of these devices, or virtually any type of wireless device.

STA 106 may include a processor (processing element) that is configured to execute program instructions stored in memory. STA 106 may perform any of the method embodiments described herein by executing such stored instructions. Alternatively, or in addition, STA 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein.

Wireless communications system 108 may include one or more wireless access points (APs) such as AP 102. AP 102 may be a stand-alone AP or an enterprise AP and may include hardware that enables wireless communication with STAs 106 such as STA 106A and STA 106B. AP 102 may also be equipped to communicate with a network 100 (e.g., a WLAN, an enterprise network, and/or another communication network connected to the Internet, among various possibilities). Thus, AP 102 may facilitate communication among STAs 106 and/or between STAs 106 and network 100. AP 102 can be configured to provide communications over one or more wireless technologies, such as any of IEEE 802.11 a, b, g, n, ac, ad, ax, ay, be, bn, and/or other 802.11 versions, or a cellular protocol, such as 5G, LTE, 3G, 2G, or 6G, including in an unlicensed band (LAA).

Network 100 may include any desired number of network nodes, terminals, and/or end hosts that are communicatively coupled together using communications paths that include wired and/or wireless links. The wired links may include cables (e.g., ethernet cables, optical fibers or other optical cables that convey signals using light, telephone cables, radio-frequency cables such as coaxial cables or other transmission lines, etc.). The wireless links may include short range wireless communications links that operate over a range of inches, feet, or tens of feet, medium range wireless communications links that operate over a range of hundreds of feet, thousands of feet, miles, or tens of miles, and/or long range wireless communications links that operate over a range of hundreds or thousands of miles.

The nodes of network 100 may be organized into one or more relay networks, mesh networks, local area networks (LANs), wireless local area networks (WLANs), ring networks (e.g., optical rings), cloud networks, virtual/logical networks, the Internet (e.g., may be communicably coupled to each other over the Internet), combinations of these, and/or using any other desired network topologies. The network nodes, terminals, and/or end hosts of network 100 may include network switches, network routers, optical add-drop multiplexers, other multiplexers, repeaters, modems, portals, gateways, servers, network cards (line cards), wireless access points, wireless base stations, and/or any other desired network components. The network nodes in network 100 may include physical components such as electronic devices, servers, computers, network racks, line cards, user equipment, etc., and/or may include virtual components that are logically defined in software and that are distributed across (over) two or more underlying physical devices (e.g., in a cloud network configuration).

The communication area (or coverage area) of AP 102 (or AP 104) may be referred to as a basic service area (BSA) or cell. AP 102 (or AP 104) and STAs 106 may be configured to communicate over the transmission medium using any of various radio access technologies (RATs) or wireless communication technologies, such as a wireless local area network (WLAN) technology (e.g., Wi-Fi), LTE, LTE-Advanced (LTE-A), 5G NR, ultra-wideband (UWB), 4G, 3G, 2G, wireless personal area network (WPAN) technology (e.g., Bluetooth), etc. A given RAT may, for example, specify the physical methodology (e.g., Layer 1 or physical layer circuitry or processing) used in implementing a corresponding communications protocol (e.g., a WLAN protocol, a wireless personal area network (WPAN) protocol, a cellular telephone protocol such as a 3G protocol, a 4G (LTE) protocol, a 5G (NR) protocol, etc., a UWB protocol, a satellite communications protocol, a satellite navigation protocol, a device-to-device (D2D) protocol, etc.).

AP 102, AP 104, and other similar access points (not shown) operating according to one or more wireless communication technologies may thus be provided as a network, which may provide continuous or nearly continuous overlapping service to STAs 106A and 106B and similar devices over a geographic area (e.g., via one or more communication technologies). A STA may roam from one AP to another AP directly or may transition between APs and cellular network cells, for example.

Note that at least in some instances STA 106 may be capable of communicating using any of multiple wireless communication technologies. For example, STA 106 might be configured to communicate using one or more of Wi-Fi, LTE, LTE-A, 5G NR, Bluetooth, UWB, one or more satellite systems (e.g., a constellation of communications satellites that communicate with one or more ground stations), etc. Other combinations of wireless communication technologies (including more than two wireless communication technologies) are also possible. Likewise, in some instances STA 106 can be configured to communicate using only a single wireless communication technology.

As shown in FIG. 1, the exemplary wireless communication system 108 can also include an AP 104, which communicates over a transmission medium with the wireless device 106B. AP 104 also provides communicative connectivity to network 100. Thus, according to some embodiments, wireless devices may be able to connect to either or both of AP 102 (or a cellular base station (BS)) and AP 104 (or another access point or BS) to access the network 100. For example, a STA may roam from AP 102 to AP 104 based on one or more factors, such as coverage, interference, and capabilities. Note that it may also be possible for AP 104 to provide access to a different network (e.g., an enterprise Wi-Fi network, a home Wi-Fi network, etc.) than the network to which the AP 102 provides access.

In some implementations, STAs 106 (e.g., STAs 106A and 106B) may include handheld devices such as smart phones or tablets, wearable devices such as smart watches or smart glasses, and/or may include any of various types of devices with wireless communication capability. For example, one or more of the STAs 106A and/or 106B may be a wireless device intended for stationary or nomadic deployment such as an appliance, measurement device, control device, etc.

STA 106B may also be configured to communicate with STA 106A. For example, STA 106A and STA 106B may be capable of performing direct device-to-device (D2D) communication. In some embodiments, such direct communication between STAs may also or alternatively be referred to as peer-to-peer (P2P) communication. The direct communication may be supported by AP 102 (e.g., AP 102 may facilitate discovery, among various possible forms of assistance), or may be performed in a manner unsupported by the AP 102. Such P2P communication may be performed using 3GPP-based D2D communication techniques, Wi-Fi-based P2P communication techniques, UWB, Bluetooth (BT), and/or any of various other direct communication techniques, according to various embodiments.

STA 106 may include one or more devices or integrated circuits for facilitating wireless communication, potentially including a WLAN (e.g., Wi-Fi) modem, a cellular modem, and/or one or more other wireless modems. The wireless modem(s) may include one or more processors (processor elements) and various hardware components as described herein. STA 106 may perform any of (or any portion of) the method embodiments described herein by executing instructions on one or more programmable processors. Alternatively, or in addition, the one or more processors may be one or more programmable hardware elements such as an FPGA (field-programmable gate array), or other circuitry, that is configured to perform any of the method embodiments described herein, or any portion of any of the method embodiments described herein. The wireless modem(s) described herein may be used in a STA as defined herein, a wireless device as defined herein, or a communication device as defined herein. The wireless modem described herein may also be used in an AP, a base station, a pico cell, a femto cell, or other similar network side device.

STA 106 may include one or more antennas for communicating using one or more wireless communication protocols or radio access technologies. In some embodiments, STA 106 can be configured to communicate using a single shared radio. The shared radio may couple to a single antenna, or may couple to multiple antennas (e.g., for multiple-input-and-multiple-output (MIMO)) for performing wireless communications. Alternatively, STA 106 may include two or more radios, each of which may be configured to communicate via a respective wireless link. Other configurations are also possible.

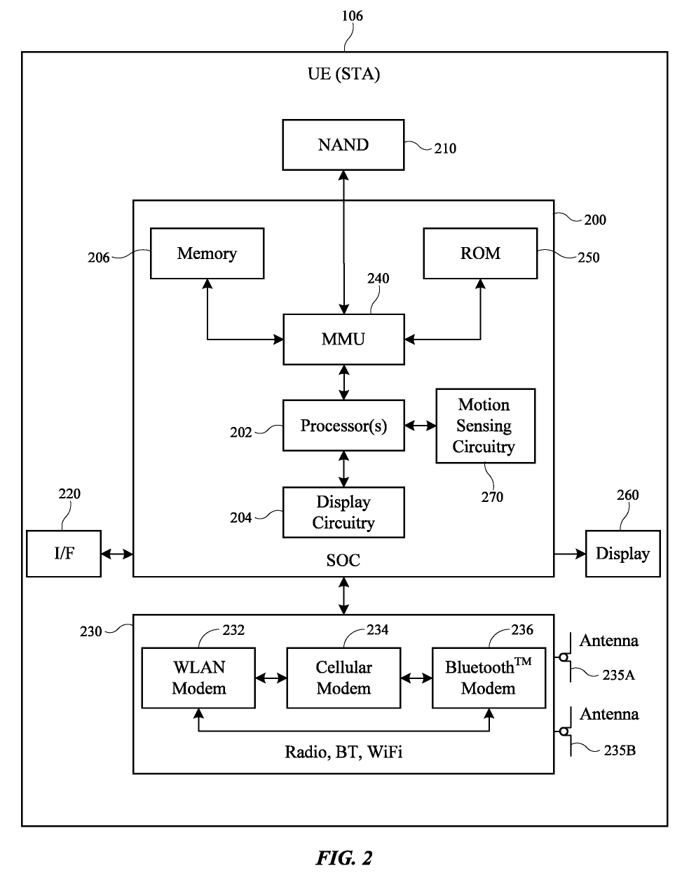

FIG. 2 is one possible block diagram of a STA device such as STA 106. STA 106 is sometimes also referred to herein as UE 106, UE device 106, device 106, electronic device 106, device 106, or client 106. STA 106 also may be referred to herein as non-AP STA 106, non-AP device 106, or non-AP client 106. As shown in FIG. 2, STA 106 may include wireless circuitry such as wireless communication circuitry 230, a subsystem such as system on chip (SOC) 200, a display such as display 260, and one or more interfaces such as connector interface (I/F) 220.

SOC 200 may include one or more portions configured for various purposes. For example, as shown in FIG. 2, SOC 200 may include one or more processors 202 and display circuitry 204. Processor(s) 202 may execute program instructions for STA 106. Display circuitry 204 may perform graphics processing and may provide display signals to display 260. Display 260 may be a touch-sensitive display, a force sensitive display, or a display without touch or force sensitivity. Display 260 may include one or more arrays of display pixels that emit light containing images, for example. Display 260 may be omitted from STA 106 if desired.

SOC 200 may also include sensor circuitry such as motion sensing circuitry 270. Motion sensing circuitry 270 may detect motion of the STA 106 using, for example, a gyroscope, accelerometer, inertial measurement unit (IMU), compass, a light-based motion sensor, a radar-based motion sensor, and/or any of various other motion sensing components. Processor(s) 202 may also be coupled to memory management unit (MMU) 240, which may be configured to receive addresses from processor(s) 202 and may translate those addresses to locations in memory or other storage circuitry (e.g., memory 206, read only memory (ROM) 250, flash (NAND) memory 210, etc.). MMU 240 may be configured to perform memory protection and page table translation or set up. In some embodiments, MMU 240 may be included as a portion of processor(s) 202.

SOC 200 may be coupled to various other circuits in STA 106. For example, SOC 200 may be coupled to various types of memory (e.g., flash memory 210), connector interface (I/F) 220 (e.g., for coupling to a computer system, dock, charging station, etc.), display 260, and wireless communication circuitry 230 (e.g., for performing wireless communications under LTE, LTE-A, 5G NR, Bluetooth, Wi-Fi, NFC, GPS, UWB, etc.).

STA 106 may include at least one antenna 235. If desired, STA 106 may include multiple antennas 235 such as at least a first antenna 235A and a second antenna 235B. STA 106 may use antennas 235 to perform wireless communication with access points, base stations, and/or other devices. For example, STA 106 may use antennas 235A and 235B to perform wireless communication with APs 102 and/or 104 of FIG. 1. As noted above, STA 106 may, in some embodiments, be configured to communicate wirelessly using multiple wireless communication standards or radio access technologies (RATs).

Wireless communication circuitry 230 may include one or more modems such as WLAN (e.g., Wi-Fi) modem 232, cellular modem 234, and/or Bluetooth modem 236. If desired, wireless communication circuitry 230 may include additional modems for handling other RATs or wireless communications technologies. STA 106 may use WLAN modem 232 (sometimes also referred to herein as Wi-Fi modem 232) to perform Wi-Fi or other WLAN communications (e.g., on an 802.11 network) with one or more external devices (e.g., AP 104 and/or 102 of FIG. 1). STA 106 may use Bluetooth modem 236 to perform Bluetooth communications or other WPAN communications with one or more external devices (e.g., another STA 106). STA 106 may use cellular modem 234 to perform cellular communications with one or more wireless base stations according to one or more cellular communication technologies (e.g., in accordance with one or more 3GPP specifications).

As described herein, STA 106 may include hardware and software components for implementing embodiments of this disclosure. For example, one or more components of the wireless communication circuitry 230 (e.g., Wi-Fi modem 232, cellular modem 234, BT modem 236) of the STA 106 may be configured to implement part or all of the methods described herein, for example, by one or more processors executing program instructions stored on a memory medium (e.g., a non-transitory computer-readable memory medium), a processor configured as a Field Programmable Gate Array (FPGA), and/or using dedicated hardware components, which may include an ASIC (Application Specific Integrated Circuit) if desired. STA 106 may include support structures such as a housing (sometimes also referred to as a case). The housing may include conductive and/or dielectric housing walls, layers, and/or other structures. Some or all of the components of STA 106 may be disposed within and/or on the housing.

If desired, STA 106 may include additional include input-output devices (not shown for the sake of clarity). The input-output devices may be used to allow data to be supplied to STA 106 and to allow data to be provided from STA 106 to external devices. The input-output devices may include user interface devices, data port devices (e.g., interface 220), touch sensors, displays (e.g., display 260), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to STA 106 using wired or wireless connections (e.g., some of the input-output devices may be peripherals that are coupled to a main processing unit or other portion of STA 106 via a wired or wireless link).

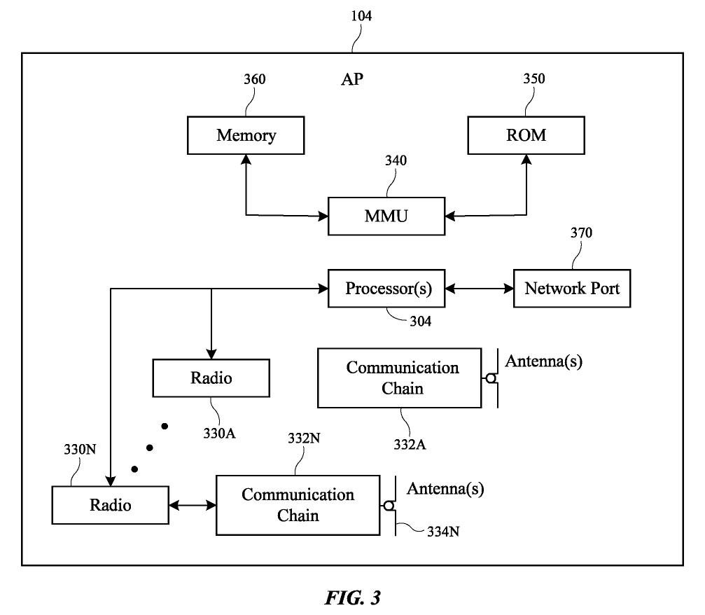

FIG. 3 is an example block diagram of an electronic device such as AP 104 (or equivalently AP 102 of FIG. 1). In some instances (e.g., in an 802.11 communication context), AP 104 may also be referred to as an AP STA. It is noted that the AP of FIG. 3 is just one example of a possible access point. As shown, AP 104 may include one or more processors 304, which may execute program instructions for AP 104. Processor(s) 304 may also be coupled to MMU 340, which may be configured to receive addresses from processor(s) 304 and to translate those addresses to locations in memory (e.g., memory 360 and ROM 350) or to other storage circuitry, circuits, or devices.

AP 104 may include at least one network port 370. Network port 370 may be configured to couple to a network and to provide multiple devices, such as STAs 106, with access to the network (e.g., network 100 of FIG. 1). Network port 370 (or an additional network port) may also, or alternatively, be configured to couple to a cellular network (e.g., a core network (CN) of a cellular service provider). The core network may provide mobility related services and/or other services to a plurality of UE devices (e.g., STAs 106). In some cases, network port 370 may couple to a telephone network via the core network, and/or the core network may provide a telephone network (e.g., among other UE devices serviced by the cellular service provider).

AP 104 may include one or more radios 330A-330N, each of which may be coupled to a respective communication chain 332 and at least one antenna 334, and possibly multiple antennas (e.g., a first radio 330A coupled to antenna 334A via communication chain 332A, an Nth radio 330N coupled to antenna 334N via communication chain 332N, etc.). Radios 330 may be configured to operate as wireless transceivers that communicate with STAs 106 via communication chains 332 and antennas 334. Antenna(s) 334A-N communicate with their respective radios 330A-N via communication chains 332A-N. Communication chains 332 may be receive chains, may be transmit chains, or may include both transmit and receive chains. Radios 330A-N may be configured to communicate in accordance with various wireless communication standards including, but not limited to, LTE, LTE-A, 5G NR, 6G, UWB, WLAN (Wi-Fi), WPAN (BT), UWB, satellite-based communications standards, etc. If desired, AP 104 may be configured to operate on multiple wireless links using the one or more radios 330A-N, where each radio is used to operate on a respective wireless link.

AP 104 may be configured to communicate wirelessly using one or multiple wireless communication standards. In some instances, AP 104 may include multiple radios, which may enable the network entity to communicate according to multiple wireless communication technologies. For example, as one possibility, AP 104 may include an LTE or 5G NR radio for performing communication according to LTE or 5G as well as a Wi-Fi radio for performing communication according to Wi-Fi. In such a case, AP 104 may be capable of operating as both a cellular base station and a Wi-Fi access point. As another possibility, AP 104 may include a multi-mode radio, which is capable of performing communications according to any of multiple wireless communication technologies (e.g., NR and Wi-Fi, NR and LTE, etc.). As still another possibility, AP 104 may be configured to act exclusively as a Wi-Fi access point (e.g., without cellular communication capability).

As described further herein, AP 104 may include hardware and software components for implementing or supporting implementation of features described herein. Processor(s) 304 of AP 104 may be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, processor(s) 304 may be configured as a programmable hardware element, such as an FPGA (Field Programmable Gate Array) or ASIC (Application Specific Integrated Circuit), or a combination thereof. Alternatively (or in addition) the processor(s) 304 of AP 104, in conjunction with one or more of the other components 330, 332, 334, 340, 350, 360, 370, may be configured to implement, or support implementation of, part or all of the features described herein.

Radio(s) 330 on AP 104 may use antenna(s) 334 (FIG. 3) and wireless communication circuitry 230 on STA 106 may use antenna(s) 235 (FIG. 2) to transmit and/or receive radio-frequency signals within different frequency bands at radio frequencies (sometimes referred to herein as communications bands or simply as a “bands”). The frequency bands handled by AP 104 and STA 106 may include satellite communications bands (e.g., the C band, S band, L band, X band, W band, V band, K band, Kₐ band, Kᵤ band, etc.), wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6 band (e.g., from 5925-7125 MHz), a Wi-Fi® 7 band, and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands,5G New Radio Frequency Range 1 (FR1) bands below 10 GHz, 5G New Radio Frequency Range 2 (FR2) bands between 20 and 60 GHz, 6G bands, sub-THz cellular bands, etc.), other centimeter or millimeter wave frequency bands between 10-300 GHz, near-field communications (NFC) frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

Antenna(s) 334 (FIG. 3) and antenna(s) 235 (FIG. 2) may be formed using any desired antenna structures. For example, the antennas may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. If desired, one or more antennas may include antenna resonating elements formed from conductive portions of a device housing (e.g., peripheral conductive housing structures extending around a periphery of a display on STA 106). Filter circuitry, switching circuitry, impedance matching circuitry, and/or other antenna tuning components may be adjusted to adjust the frequency response and wireless performance of the antennas over time. If desired, multiple antennas may be implemented as a phased array antenna (e.g., where each antenna forms a radiator or antenna element of the phased array antenna, which is sometimes also referred to as a phased antenna array). In these scenarios, the phased array antenna may convey radio-frequency signals within a signal beam. The phases and/or magnitudes of each radiator in the phased array antenna may be adjusted so the radio-frequency signals for each radiator constructively and destructively interfere to steer or orient the signal beam in a particular pointing direction (e.g., a direction of peak signal gain). The signal beam may be adjusted or steered over time.

Wireless communication circuitry 230 may convey radio-frequency signals using antenna(s) 235 (FIG. 2). Radio(s) 330 may convey radio-frequency signals using antenna(s) 334 (FIG. 3). The term “convey radio-frequency signals” as used herein means the transmission and/or reception of the radio-frequency signals (e.g., for performing unidirectional and/or bidirectional wireless communications with external wireless communications equipment). The term “convey wireless data” as used herein means the transmission and/or reception of the wireless data (e.g., as carried by corresponding radio-frequency signals). Antennas may transmit radio-frequency signals by radiating the radio-frequency signals into free space (or to free space through intervening device structures such as a dielectric cover layer). Antennas may additionally, or alternatively, receive radio-frequency signals from free space (or through intervening devices structures such as a dielectric cover layer). The transmission and reception of radio-frequency signals by antennas each involve the excitation or resonance of antenna currents on an antenna resonating element in the antenna by the radio-frequency signals within the frequency band(s) of operation of the antenna.

Wireless communication circuitry 230 may be coupled to antenna(s) 235 (FIG. 2) over one or more radio-frequency transmission lines. Radio(s) 330 may be coupled to antenna(s) 334 (FIG. 3) over one or more radio-frequency transmission lines. Communication chain(s) 332 (FIG. 3) may be disposed on the radio-frequency transmission lines between antenna(s) 334 and radio(s) 330. The radio-frequency transmission lines may include coaxial cables, microstrip transmission lines, stripline transmission lines, edge-coupled microstrip transmission lines, edge-coupled stripline transmission lines, transmission lines formed from combinations of transmission lines of these types, etc. The radio-frequency transmission lines may be integrated into rigid and/or flexible printed circuit boards if desired. One or more of the radio-frequency lines may be shared between radios or modems if desired. Radio-frequency front end (RFFE) modules may be interposed on one or more of the radio-frequency transmission lines if desired (e.g., within communication chain(s) 332 of FIG. 3 or within wireless communication circuitry 230 of FIG. 2). The radio-frequency front end modules may include substrates, integrated circuits, chips, or packages that are separate from the radios or modems and may include filter circuitry, switching circuitry, amplifier circuitry, impedance matching circuitry, radio-frequency coupler circuitry, and/or any other desired radio-frequency circuitry for operating on the radio-frequency signals conveyed over the radio-frequency transmission lines.

Processor(s) 202 (FIG. 2) and processor(s) 304 (FIG. 3) may each include one or more processors such as microprocessors, microcontrollers, digital signal processors, host processors, baseband processing circuitry (e.g., one or more baseband processors or baseband processor integrated circuits), application specific integrated circuits (ASICs), FPGAs, central processing units (CPUs), graphics processing units (GPUs), etc. If desired, radio(s) 330 (FIG. 3) and/or wireless communication circuitry 230 may also include one or more processors. Baseband circuitry in STA 106 and/or AP 104 may, for example, access a communication protocol stack on corresponding storage circuitry (e.g., memory 206 of FIG. 2 or memory 360 of FIG. 3) to: perform user plane functions at a physical (PHY) layer, data link or media access control (MAC) layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

AP 104 (or AP 102 of FIG. 1) may communicate with a STA 106 over a corresponding wireless communication link. Radio-frequency signals may be wirelessly conveyed between the radios and antennas on AP 104 and STA 106 to support the wireless communication link. The radio-frequency signals may include wireless data modulated onto one or more carriers of the radio-frequency signal (e.g., by a transmitter in radio 330 of AP 104 or a transmitter in a modem on wireless communication circuitry 230 of STA 106). The wireless data may be organized, modulated onto the radio-frequency signals, and demodulated from the radio-frequency signals (e.g., by a receiver in radio 330 of AP 104 or a receiver in a modem on wireless communication circuitry 230 of STA 106) according to a corresponding communications protocol or standard (e.g., an IEEE 802.11 protocol or standard). The radio-frequency signals may be conveyed (carried) across the transmission medium in one or more frequency bands associated with the communications protocol.

Implementations in which AP 104 and STA 106 communicate according to an IEEE 802.11 protocol or standard are described herein as an example. Under an 802.11 protocol, the wireless data is organized into a series or flow of frames (e.g., media access control (MAC) frames) carried by the radio-frequency signals. The frames, which are sometimes also referred to as packets, may include management frames, control frames, data frames, beacon frames, association frames, authentication frames, acknowledgement (ACK) frames, block ACK frames, trigger frames, trigger response frames, probe frames, association frames, reassociation frames, and/or other types of frames. Each frame may include a frame header, body (e.g., after the header), and trailer (e.g., after the body). The header may include, for example, source address (SA) information identifying the transmitter of the frame (sometimes also referred to herein as transmitter address (TA) information that identifies a corresponding TA), destination address information identifying the intended recipient of some or all of the frame (sometimes also referred to herein as recipient address (RA) information that identifies a corresponding RA), routing information, identifier information identifying one or more aspects of some or all of the frame (e.g., information identifying the type of frame), Association Identifier (AID) fields, control information, etc. The body may include, for example, a data payload (e.g., a payload of voice data, video data, web browsing data, application data, etc.). The trailer may include checking information that helps to verify the frame to the recipient. The checking information may include a frame check sequence (FCS) or cyclic redundancy check (CRC) field, as examples. If desired, the header, body, and/or trailer may include one or more message integrity check (MIC) fields (e.g., hash values or the output of other cryptographic functions that take as an input different portions of the frame and that are used to verify the integrity of the frame when received by a recipient). Fields of a frame or message are sometimes also referred to herein as elements of the frame or message.

Under a bidirectional communications link between AP 104 and STA 106, frames are conveyed both from AP 104 to STA 106 and from STA 106 to AP 104. STA 106 may transmit one or more ACK frames or block ACK frames to AP 104 to acknowledge the successful receipt of one or more frames transmitted by AP 104. AP 104 may transmit one or more ACK frames or block ACK frames to STA 106 to acknowledge the successful receipt of one or more frames transmitted by AP STA 106.

Radio-frequency signals are transmitted in a downlink (DL) direction from AP 104 to STA 106. Radio-frequency signals transmitted in the DL direction are sometimes also referred to herein as DL signals. The DL signals may carry DL data (e.g., DL frames transmitted by AP 104 to STA 106). Radio-frequency signals are transmitted in an uplink (UL) direction from STA 106 to AP 104. Radio-frequency signals transmitted in the UL direction are sometimes also referred to herein as UL signals. The UL signals may carry UL data (e.g., UL frames transmitted by STA 106 to AP 104).

A given AP 104 may support, maintain, and/or implement a Basic Service Sets (BSS) used in communicating with at least one STA 106 (e.g., according to the corresponding 802.11 protocol). If desired, a single physical AP 104 may concurrently support, maintain, and/or implement multiple BSS’s (e.g., may support wireless communications with different STAs associated with multiple BSS’s). The AP may, for example, utilize a first BSS to communicate with a first set of one or more STAs 106, a second BSS to communicate with a second set of one or more STAs 106, etc. When communications between AP 104 and a given STA 106 are initiated, the STA associates (registers) with AP 104 and is thereafter associated with a corresponding BSS of the AP (a procedure referred to as Association). A BSS may include and/or identify corresponding communications/operating parameters, device capabilities, security level information, and/or other information associated with the communications services provided by AP 104 to one or more STAs under that BSS.

Each BSS may be identified by a corresponding BSS identifier (BSSID). The BSSID may, for example, represent or correspond to a particular network address (e.g., MAC address) and/or wireless network name that is established, possessed, and/or maintained by the AP for wirelessly communicating using the corresponding BSS. If desired, a given AP 104 may concurrently or simultaneously support, implement and/or maintain multiple BSSIDs, in a communications scheme sometimes referred to herein as performing multiple BSSID (M-BSSID) operations or M-BSSID communications. When configured to perform M-BSSID communications, each BSSID maintained by AP 104 corresponds to a different network address (e.g., MAC address) and wireless network name maintained and operated by the AP.

Consider one example in which AP 104 is a Wi-Fi router or hot spot on a college campus and that is configured to perform M-BSSID communications. In this example, AP 104 may concurrently maintain a first BSSID named “STUDENT” for STAs 106 operated by students of the college campus and corresponding to a first MAC address of AP 104, a second BSSID named “STAFF” for STAs 106 operated by staff of the college campus and corresponding to a second MAC address of AP 104, a third BSSID named “GUEST” for STAs 106 operated by guests of the college campus, etc. Each BSSID may have different respective operating characteristics, security configurations, and/or settings. When a STA 106 enters the wireless coverage area of an AP, the user of the STA may interact with a user interface of the STA to select one of the BSSIDs of the AP to connect to. The AP may then associate the STA with or to that BSSID (e.g., if the STA meets one or more security conditions related to the BSSID such as being registered to a user who is granted access to that BSSID, providing a correct password to access that BSSID, etc.). Once associated with a given BSSID, the STA and the AP use that BSSID (e.g., the BSS identified by the BSSID) to convey wireless data. This example is illustrative and non-limiting.

If desired, two or more STAs 106 in wireless communication system 108 (FIG. 1) may communicate with each other over a corresponding peer-to-peer (P2P) link (sometimes also referred to herein as a P2P communication link). The STAs may convey radio-frequency signals directly with each other over the P2P link (e.g., without the radio-frequency signals being received, forwarded, and/or relayed by an intervening AP). These radio-frequency signals may propagate over the transmission medium between the STAs and are sometimes also referred to herein as P2P signals. The P2P signals may carry any desired frames associated with the corresponding communications protocol (e.g., a Wi-Fi or 802.11 protocol). After a STA 106 has associated or is able to associate with an AP 104, that STA 106 is sometimes also referred to herein as a client of the AP. The P2P signals conveyed between associated STAs 106 are therefore sometimes also referred to herein as client-to-client (C2C) signals and the corresponding P2P link is sometimes also referred to herein as a C2C link or a C2C communication link. The communications links between APs 104 and STAs 106 (e.g., as maintained by radio-frequency signals conveyed between STAs 106 and APs 104, such as UL and/or DL signals) are sometimes also referred to herein as AP-STA links or AP-client links.

Some versions of the Wi-Fi protocol (e.g., a Wi-Fi 6 protocol) may involve transmission in one or more frequency channels (CH) at or near 6 GHz. As these channels are in the same band as incumbent operation, regulatory requirements may be implemented by the protocol to help manage communications at these frequencies in a manner that limits or eliminates the impact to the incumbent operations (e.g., by imposing one or more maximum transmit power limits on signal transmission by the AP and/or STA). The regulatory requirements may include or be associated with one or more regulatory modes applicable to AP-client and P2P links/operation. The protocol may include specifications and/or constraints for operating in each of the regulatory modes. Each regulatory mode may be associated with a different deployment and/or operating scenario/environment for APs 104 and STAs 106 in wireless communication system 108.

The regulatory modes may support one or more infra-BSS modes (e.g., primarily associated with different modes for AP-client links between APs 104 and STAs 106) and may support one or more P2P modes (e.g., associated with P2P links between STAs 106). Each regulatory mode may involve corresponding maximum transmit power levels of the AP and/or the STA for AP-client and/or P2P links (e.g., maximum transmit power levels that help to ensure that regulatory requirements associated with the regulatory modes are met during signal transmission).

Infra-BSS modes that are supported, implemented, and/or defined by the protocol may include, for example, a low power indoor (LPI) mode (e.g., associated with APs 104 that are only deployed indoors), a standard power (SP) mode (e.g., associated with APs 104 that may be deployed indoors or outdoors), and a composite (LPI/SP) mode (e.g., associated with APs 104 that may be deployed indoors but that may operate at higher maximum transmit power levels than APs operating in the LPI mode). The LPI mode may be associated with (e.g., may involve imposition of) relatively low maximum transmit power levels (e.g., 24 dBm for STAs 106 and 30 dBm for APs 104). The SP mode may be associated with (e.g., may involve imposition of) relatively high maximum transmit power levels (e.g., 30 dBm for STAs 106 and 36 dBm for APs 104). The composite mode may be associated with (e.g., may involve imposition of) a mix of maximum transmit power levels (e.g., 24 of 30 dBm for STAs 106 and 30 or 36 dBm for APs 104).

P2P modes that are supported, implemented, and/or defined by the protocol may include, for example, a very low power (VLP) mode (e.g., for STAs 106 that are within coverage of an LPI AP, that are able to hear and decode signals from the LPI AP, and/or that communicate with each other while both STAs are indoors or outdoors), a C2C mode (e.g., associated with STAs 106 that communicate with each other while both STAs are indoors), and/or a geofenced variable power (GVP) mode (e.g., associated with STAs 106 that communicate with each other while indoors or outdoors but with different geofences that are used to impose different regions/areas with different maximum transmit power levels and/or that are used to define one or more exclusion zones). The VLP mode may be associated with (e.g., may involve imposition of) a very low maximum transmit power level at STAs 106 (e.g., 14 dBm). The C2C mode may be associated with (e.g., may involve imposition of) a higher maximum transmit power level at STAs 106 (e.g., 24 dBm). The GVP mode may be associated with (e.g., may involve imposition of) a mix of different maximum transmit power levels at STAs 106, depending on the geographic location of the STAs relative to one or more geofences (e.g., 14-21 dBm).

It may be desirable for STAs 106 to have information about the regulatory modes supported and/or implemented by the APs 104 in wireless communication system 108 and other STAs for P2P mode. The STAs 106 may, for example, use this information to increase wireless performance level and/or efficiency in subsequent communications with APs 104. The protocol may include a signaling mechanism between STAs 106 and APs 104 (e.g., over AP-client links) that serves to inform STAs 106 of the regulatory modes supported and/or being implemented by APs 104. However, it may also be desirable for the protocol to include, define, or specify a signaling mechanism between STAs 106 that communicate via P2P links. This signaling mechanism may, for example, serve to inform a first STA 106 of the capabilities, regulatory modes, and/or observations of a second STA 106 that is in communication with the first STA 106 (e.g., capabilities, regulatory modes, and/or observations of APs 104 that are visible/known to and/or in communication with the second STA but that might not be visible to, known to, or in communication with the first STA). The first STA may use this information to increase the wireless performance and/or efficiency of its P2P link with the second STA and/or to increase the wireless performance and/or efficiency of subsequent communications with APs 104 in wireless communication system 108.

When operating in the P2P mode, client devices (STAs 106) that are in the coverage area of indoor APs 104 may communicate directly with each other (e.g., may establish a P2P link) at a maximum transmit power level authorized for indoor clients in the C2C mode while associated or able to associate with the indoor APs 104. The criteria for a client device to benefit from indoor regulation (e.g., higher power levels) may be control by an indoor AP 104 or may be the ability to receive (e.g., successfully decode) an enabling signal from an AP 104 at a power level above a predetermined threshold. To help ensure that mobile/portable clients stay within the required coverage area, client devices may need to receive and successfully decode the enabling signal frequently. If the enabling signal is at a lower power than the predetermined threshold, the C2C link may not be able to use the indoor maximum transmit power level and may instead continue using the lower maximum transmit power level associated with the VLP or GVP mode.

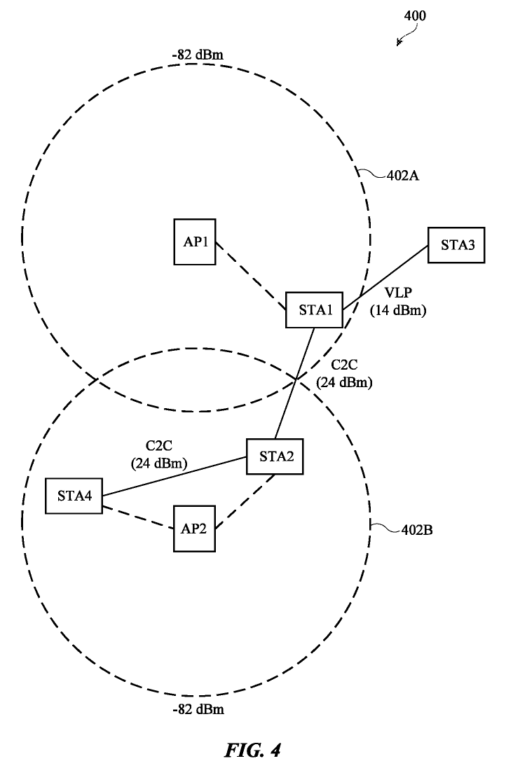

In practice, there are many possible deployments for STAs and APs that may impose different requirements for different regulatory modes, which can also vary by region, area, jurisdiction, and/or regulator. FIG. 4 illustrates one example deployment 400 of wireless communication system 108 (FIG. 1) that includes a first AP 104 (AP1), a second AP 104 (AP2), a first STA 106 (STA1), a second STA 106 (STA2), a third STA 106 (STA3), and a fourth STA 106 (STA4). AP1 and AP2 of FIG. 4 may, for example, be APs that support an LPI mode and that are configured to perform communications in the LPI mode (e.g., AP1 and AP2 may be LPI APs). The example of FIG. 4 is for illustration purposes and is non-limiting. Deployment 400 may have other configurations, any desired number of APs, and any desired number of STAs.

As shown in FIG. 4, AP1 may enable clients (illustrated using dashed lines) within a corresponding coverage area 402A (e.g., a region or cell where signals transmitted by AP1 can be received by STAs at -82 dBm or higher). Similarly, AP2 may enable clients within a corresponding coverage area 402B (e.g., a region or cell where signals transmitted by AP2 can be received by STAs at -82 dBm or higher). An AP is sometimes also referred to as an “enabling” AP for STAs within its coverage area (e.g., for STAs that are able to receive and decode enabling signals from the AP at a predetermined power level or higher). In the example of FIG. 4, for instance, AP1 is an enabling AP of STA1 (e.g., STA1 may be enabled by AP1 while within coverage area 402A) and AP2 is an enabling AP of STA2 and STA4 (e.g., STA2 and STA4 may be enabled by AP2 while within coverage area 402B).

In the example of FIG. 4, dashed lines indicate when a STA is enabled by a corresponding AP whereas solid lines indicate an established communication link (e.g., a P2P link or an AP-STA link). If desired, a STA 106 may associate with one or more of its enabling APs 104. However, a STA 106 need not associate with its enabling APs (e.g., a STA 106 may be enabled by but may be unassociated with a given AP). For example, STA1 may associate with its enabling AP1 and may then convey wireless data with AP1 over a corresponding AP-client link. Similarly, STA2 and STA4 may associate with AP2 and may convey wireless data with AP2 over respective AP-client links.

In the example of FIG. 4, because STA2 is enabled by AP2, STA2 may be able to use the relatively high maximum transmit power level associated with operating in the C2C regulatory mode. For example, STA2 may perform C2C communications over a first C2C link with STA4 at a C2C mode maximum transmit power level of 24 dBm. Because STA4 is also enabled by AP2, the C2C mode maximum transmit power level of 24 dBm may be used over both directions of the C2C link between STA4 and STA2. STA2 may be able to use the same C2C mode with maximum transmit power level of 24 dBm with STA1 if regulation allows enabling by different APs for C2C clients. However, STA2 may be unable to use the same C2C mode with maximum transmit power level of 24 dBm with STA1 if regulation does not allow enabling by different APs for C2C and the regulatory requirement requires both STAs to be enabled by the same LPI AP.

In the example of a network with Infra-BSS and a P2P group (see, e.g., FIG. 10), at the same time, if regulation allows enabling by different APs, because STA1 is enabled by AP1, STA1 may be able to use the C2C mode maximum transmit power level of 24 dBm in a C2C link with STA2, even though STA1 and STA2 are enabled by different APs. STA2, which is enabled by AP2, may also be able to use the C2C mode maximum transmit power level when transmitting signals to STA1 over the C2C link between STA1 and STA2. However, a P2P link between STA1 and STA3 may be unable to support the C2C mode maximum transmit power level because STA3 is not enabled by AP1 or another suitable LPI AP. As such, STA1 and STA3 may transmit signals over the P2P link between STA1 and STA3 using a VLP mode maximum transmit power level (e.g., 14 dBm) that is lower than the C2C mode maximum transmit power level. The lower maximum transmit power level associated with the link between STA1 and STA3 may, in some situations, cause communications over the link to exhibit lower performance levels than if the link were maintained using the C2C maximum transmit power level.

In FIG. 4, consider another example deployment in which a single AP2 enables both STA2 and STA4 and in which STA2 and STA4 communicate with each other over a C2C link. In this example, both STAs may receive an enabling signal from the AP (e.g., a beacon frame) at a signal strength above a predetermined threshold (e.g., -82 dBm/20 MHz in some jurisdictions). Both STAs may associate with the same BSSID of the AP if desired. Both STAs may utilize the same maximum transmit power level as the other clients of the AP (e.g., LPI in some jurisdictions). Both STAs may also need to verify signal strength of the enabling signal periodically (e.g., every four seconds in some jurisdictions).

In addition, some regulators (e.g., jurisdictions, regulatory bodies, etc.) may include no restrictions on clients to be enabled by the same or different indoor APs to utilize the highest maximum transmit power level for signal transmission. Moreover, some regulators may require two STAs that communicate over a C2C link to be enabled by the same AP. Furthermore, some regulators may allow two STAs in communication over a C2C link to be enabled by different APs within the same network (e.g., where the network has an associated service set identifier (SSID) shared by the APs of the network even though the APs may have different respective BSSIDs).

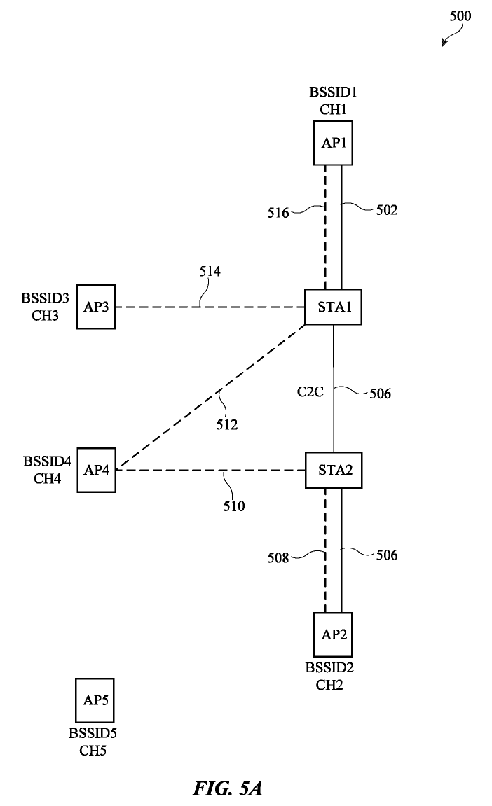

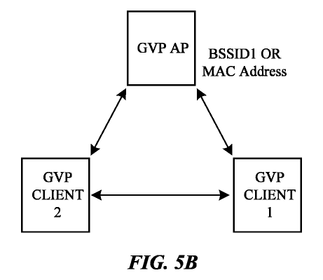

For example (e.g., in FIG. 5A), assuming that regulation allows enabling by different APs in the same network, a wireless communication system may include a first AP having a first BSSID such as BSSID1 and having a second BSSID such as BSSID2, but where the first AP and the second AP belong to the same network (e.g., an enterprise network) having a corresponding SSID such as SSID1. In this example, a first STA may associate with or be enabled by (e.g., without association) the first AP, BSSID1, and SSID1, the second STA may associate or be enabled by (e.g., without association) the second AP, BSSID2, and SSID1, and the first and second STAs may communicate with each other over a C2C link. This type of deployment may, for example, address impact on P2P communications in multi-AP enterprise deployments. Once a condition for the enabling APs is met, the C2C link may be maintained over a different channel than the AP-client link between the first AP and the first STA and the AP-client link between the second AP and the second STA.

FIG. 5A shows another example of a deployment 500 that includes two STAs in communication over a C2C link and that are associated with different APs 104 while also being enabled by common APs 104 of wireless communication system 108. For instance, as shown in FIG. 5A, deployment 500 may include at least a first AP 104 such as AP1, a second AP 104 such as AP2, a third AP 104 such as AP3, a fourth AP 104 such as AP4, and a fifth AP 104 such as AP5. Deployment 500 may also include a first STA 106 such as STA1 and a second STA 106 such as STA2. AP1 may have a corresponding BSSID such as BSSID1 and may communicate over one or more AP-client links within channel CH1. AP2 may have a corresponding BSSID such as BSSID2 and may communicate over one or more AP-client links within channel CH2. AP3 may have a corresponding BSSID such as BSSID3 and may communicate over one or more AP-client links within channel CH3. AP4 may have a corresponding BSSID such as BSSID4 and may communicate over one or more AP-client links within channel CH4. AP5 may have a corresponding BSSID such as BSSID5 and may communicate over one or more AP-client links within channel CH5.

The dashed lines in FIG. 5A illustrate how STA1 and STA2 are enabled by corresponding APs 104 in deployment 500. For example, as shown by dashed line 516, STA1 is enabled by AP1. STA1 may also be enabled by AP3 (as shown by dashed line 514) and by AP4 (as shown by dashed line 512). In this deployment, STA2 and STA1 are enabled by an overlapping set of APs. For example, as shown by line 510, STA2 may also be enabled by AP4. Finally, as shown by dashed line 508, STA2 may also be enabled by AP2. The solid lines in FIG. 5A illustrate AP-client links (e.g., associations) of STA1 and STA2. For example, as shown by line 502, STA1 may be associated with AP1 and BSSID1. As shown by line 506, STA2 may be associated with AP2 and BSSID2. As shown by line 504, STA1 and STA2 may communicate with each other over a corresponding C2C link. In this example, AP5 does not enable STA1 or STA2 but its channel CH5 can be used by C2C links between STA1 or STA2, as there is minimal or no interference between C2C links and AP-client communications corresponding to BSSID5.

This type of deployment can involve many different types of regulatory modes and corresponding characteristics, constraints, and/or requirements on the C2C link between STA1 and STA2. For example, a same-AP restriction on C2C communications may be imposed due to AP4 (BSSID4) enabling both STA1 and STA2. Low latency may also be configured by BSSID4 operating in channel CH4. Coexistence with infra-BSS may also be supported by C2C communication operating in channel CH5. A stable C2C link between STA1 and STA2 may be enabled by BSSID1 and BSSID2. This example is illustrative and non-limiting.

In general, a STA may be enabled by multiple APs 104 that belong to the same SSID, or multiple APs 104 that belong to different SSIDs. The enabling APs may be on different channels at or near 6 GHz. As can be seen by these examples, there are many different possible deployment conditions that two STAs performing C2C communications may encounter in the field. This means that different STAs 106 may need to utilize different maximum transmit power levels depending on their supported and/or implemented regulatory modes (e.g., VLP vs C2C modes, or C2C modes, depending on the APs enabling the STA and the regulatory modes supported and/or implemented by those APs). It is beneficial for the STA (and network performance) if the STAs are able to signal some or all of this information with each other over a corresponding P2P link.

For example, peer STAs (e.g., STAs or clients that communicate with each other over a C2C link) may benefit from knowledge of the enabling APs of the other STA, their operating channel(s), their operating characteristic(s), and/or their supported and/or implemented regulatory modes (e.g., maximum transmit power levels imposed on C2C and/or AP-client communications). One or both STAs may use the signaled information to optimize the efficiency of communications over the P2P link and/or with other APs in the network. This may also help peer STAs to attempt to verify whether they are enabled by the same AP(s) as the other STA, which may help to further improve network performance and P2P communication efficiency (e.g., if one STA needs to utilize a relatively low maximum transmit power level for C2C communications as dictated by its enabling AP(s), the other STA may save power by limiting its maximum transit power level for C2C communications accordingly even if that STA is enabled by a different AP that allows the STA to utilize a higher maximum transmit power level for C2C communications).

FIG. 5B shows another example of a deployment that includes a GVP AP, a first STA such as GVP Client 1, and a second STA such as GVP Client 2. As shown in FIG. 5B, this deployment includes two GVP clients in communication over a GVP C2C link and that are both under control of the same GVP AP. In this example, the GVP clients discover that they both are under control of or enabled by the same GVP AP when they recognize the peer device has advertised the MAC address of the GVP AP.

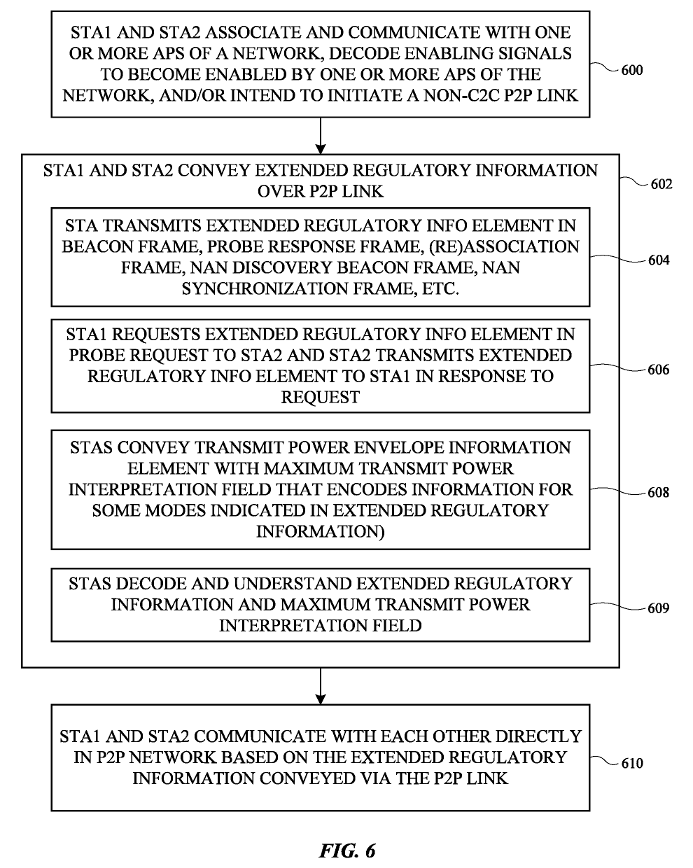

In implementations that are described herein as an example, the protocol associated with P2P communications between STAs 106 (e.g., a Wi-Fi 6E or 7 protocol) may define and utilize an Extended Regulatory Information Element that is used to signal this information between the STAs. FIG. 6 is a flow chart of illustrative operations associated with the transmission of an Extended Regulatory Information Element conveyed between STAs 106. The operations of FIG. 6 may, for example, be performed by a first STA 106 (e.g., STA1 of FIG. 4, FIG. 5A, GVP Client 1 in FIG. 5B, or a similar STA in another deployment) and a second STA 106 (e.g., STA2 of FIG. 4, FIG. 5A, GVP Client 2 in FIG. 5B, or a similar STA in another deployment) of a wireless communication system 108 having a set of one or more APs 104 (e.g., AP1, AP2 of FIGS. 4 or 5, AP3, AP4, AP5 of FIG. 5A, the GVP AP of FIG. 5B, or similar APs in other deployments). Examples in which the first STA is referred to as STA1 and the second STA is referred to as STA2 are sometimes described herein for the sake of illustration but may, in general, be replaced with any desired STAs in any desired deployment.

At operation 600, the first STA (e.g., STA1) and the second STA (e.g., STA2) may perform an initial communication operation. The initial communication operation may include the first STA (STA1) associating with one or more of the APs 104 in wireless communication system 108 that enable the first STA and/or the second STA (STA2) associating with one or more of the APs 104 in wireless communication system 108 that enable the second STA. The enabling AP(s) of STA1 may be different from the enabling AP(s) of STA2 or, in some situations, one or more AP(s) may enable both STA1 and STA2. The AP(s) (e.g., BSSID(s)) that associate with STA1 may be different from the AP(s) (e.g., BSSID(s)) that associate with STA2 or, in some situations, one or more AP(s) (e.g., BSSID(s)) may associate with both STA1 and STA2. The AP(s) enabling and/or associated with STA1 and STA2 may belong to the same network and/or SSID or, in some situations, may belong to different networks and/or SSIDs. The operations of FIG. 6 may be performed for any desired deployment of APs 104 in wireless communications system 108. If desired, one or both of STA1 and STA2 may be enabled by the AP(s) without being associated with the AP(s). For example, the initial communication operation may include STA1 and STA2 being enabled by the AP(s) (e.g., where STA1 and STA2 are able to successfully decode enabling signals of at least a threshold power level). Additionally, or alternatively, the initial communication operation may include the STAs intending or attempting to initiate a non-C2C P2P link (e.g., operation 600 may also be applicable to other non-C2C links).

Association may involve, for example, the transmission of at least an association request by a STA to an AP and transmission of a corresponding association response by the AP to the STA. If desired, association may also involve, prior to the association request, transmission of a probe request by the STA to the AP, transmission of a probe response by the AP to the STA, transmission of an authentication request by the STA to the AP, and/or transmission of an authentication response by the AP to the STA. After STA1 has associated with an AP, STA1 may convey wireless data (e.g., physical protocol data units (PPDUs)) with the AP over a corresponding AP-client link between STA1 and the AP. Similarly, after STA2 has associated with an AP, STA2 may convey wireless data (e.g., PPDUs) with the AP over a corresponding AP-client link between STA2 and the AP.

At operation 602, STA1 and STA2 may initiate a P2P link. This may include transmission of P2P signals between STA1 and STA2. The P2P link (e.g., the P2P signals or C2C signals) may convey extended regulatory information (e.g., transmitted by STA1 to STA2 and/or transmitted by STA2 to STA1). The extended regulatory information transmitted by a STA may include information identifying the AP(s) enabling and/or associated with that STA and/or information about the AP(s) (e.g., characteristics, regulatory modes, imposed requirements such as maximum transmit power levels, etc.).

If desired, the extended regulatory information may be included within an Extended Regulatory Information (info) Element in one or more frames transmitted from STA1 to STA2 and/or from STA2 to STA1 (at operation 604). The Extended Regulatory Information Element may include one or more extended regulatory information fields. STA1 and/or STA2 may transmit the Extended Regulatory Information Element in a Beacon frame, a Probe Request frame, a Probe Response frame, an Association Request/Response frame, a Reassociation Request/Response frame, a Neighbor Awareness Networking (NAN) Discovery Beacon frame, a NAN Synchronization frame, and/or in any other desired frame structure (e.g., as defined or specified by the protocol governing the C2C link and/or the AP-client links). Operation 602 may be applicable to other non-C2C P2P links if desired.

If desired, at operation 606, STA1 may transmit a request for the Extended Regulatory Information Element of STA2 to STA2 over the P2P link (e.g., in a probe request). In response to receiving the request, STA2 may transmit its Extended Regulatory Information Element to STA1 over the P2P link (e.g., in a probe response). If desired, at operation 608, STA1 and STA2 may convey a Transmit Power Envelope (TPE) Information Element (IE) over the C2C link. The TPE IE may include a maximum transmit power level interpretation field. The maximum transmit power level interpretation field may encode information about one or more regulatory modes of the AP(s) that are identified by the Extended Regulatory Information Element. If desired, at operation 609, the STAs may decode, store, process, and/or understand extended regulatory information in a received Extended Regulatory Information Element and/or a maximum transmit power interpretation field in a received TPE IE.

At operation 610, STA1 and STA2 may continue to communicate with each other over the P2P link. If desired, STA1 may transmit P2P signals to STA2 over the P2P link using or based on one or more Extended Regulatory Information Elements received from STA2 over the P2P link. If desired, STA2 may transmit P2P signals to STA1 over the P2P link using or based on one or more Extended Regulatory Information Elements received from STA1 over the P2P link. Additionally, or alternatively, STA2 may communicate with one or more APs 104 (e.g., over AP-client links) that are associated with STA2 using or based on one more Extended Regulatory Information Elements received from STA1 over the P2P link. These communications may, for example, be performed using one or more transmit characteristics/timings (e.g., maximum transmit power levels) and/or may include information that is based on information from a received Extended Regulatory Information Element, as examples.

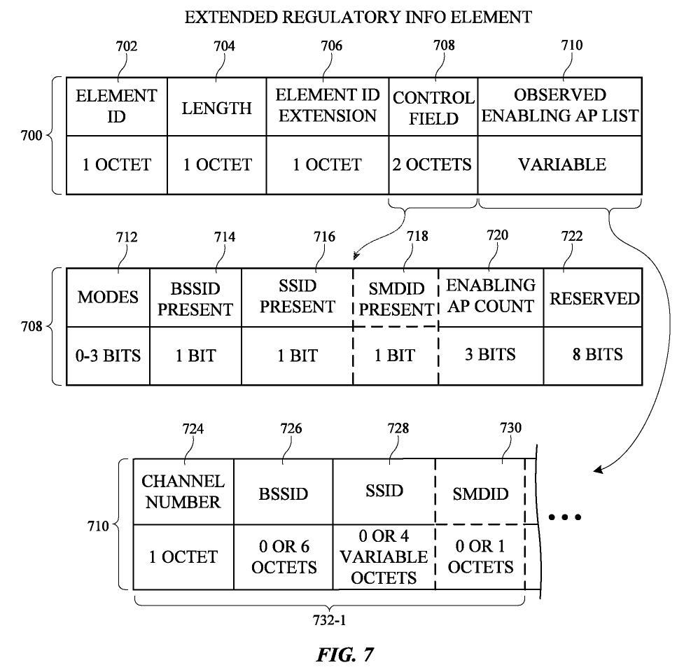

FIG. 7 is a diagram of extended regulatory information that may be conveyed between STA1 and STA2 over a C2C link (e.g., while processing operation 602 of FIG. 6) to provide information of potential links suitable for C2C operation from the perspective of each STA. As shown at the top of FIG. 7, an Extended Regulatory Information (Info) Element 700 may be conveyed between STA1 and STA2, over any link that the two STAs may communicate in (e.g., the P2P link or a different link). Extended Regulatory Information Element 700 may be included in a portion (e.g., one or more header fields) of a Beacon frame, a Probe Request frame, a Probe Response frame, an Association Request/Response frame, a Reassociation Request/Response frame, a Neighbor Awareness Networking (NAN) Discovery Beacon frame, a NAN Synchronization frame, and/or in any other desired frame conveyed between STA1 and STA2. If desired, Extended Regulatory Information Element 700 may be included in the frame in addition to an existing Regulatory Info Element that signals, indicates, or identifies one or more infra-BSS modes. Alternatively, Extended Regulatory Information Element 700 may replace the existing Regulatory Info Element that signals the infra-BSS mode(s) or may be incorporated into and/or combined with the existing regulatory info element that signals the infra-BSS mode(s).

Extended Regulatory Information Element 700 may include an element identifier (ID) field 702 (e.g., a single-octet field or a field of another length), a length field (e.g., a single-octet field or a field of another length), an element ID extension field 706 (e.g., a single-octet field or a field of a different length), a control field 708 (e.g., a two-octet field or a field of a different length), and an observed enabling AP list field 710 (e.g., having variable length). Observed enabling AP list field 710 is sometimes also referred to herein simply as observed enabling AP list 710, observed AP list 710, or enabling AP list 710. Length field 704 may be between element ID field 702 and element ID extension field, element ID extension field 706 may be between length field 704 and control field 708, and/or control field 708 may be between element ID extension field 706 and observed enabling AP list field 710. If desired, control field 708 may immediately follow element ID extension field 706 and/or may immediately precede observed enabling AP list field 710. Observed enabling AP list field 710 may be a last (final) field of Extended Regulatory Information Element 700 if desired. More generally, element ID field 702, length field 704, element ID extension field 706, control field 708, and observed enabling AP list field 710 may be in any desired order in Extended Regulatory Information Element 700. If desired, one or more additional fields may be included in Extended Regulatory Information Element 700 before element ID field 702, between element ID field 702 and length field 704, between length field 704 and element ID extension field 706, between element ID extension field 706 and control field 708, between control field 708 and observed enabling AP list field 710, and/or after observed enabling AP list field 710.

In some embodiments, an additional field, named Number of Modes, may be present between Element ID extension field 706 and Control field 708. The Number of Modes field indicates multiple occurrences of the subsequent Control field 708 and Observed Enabling AP List field 710. For instance, if the Number of Modes field indicates a value of 3, that means that there would a first instance of Control field 708 and Observed Enabling AP List field 710, followed by a second instance of Control field 708 and Observed Enabling AP List field 710, and followed by a third instance of Control field 708 and Observed Enabling AP List field 710. In each of the instances of Control field 708 and Observed Enabling AP List field 710, the information contained therein may be different from another instance. This representation indicates multiple modes of operation where: the first instance indicates one of mode of operation, indicated by the value carried in the Modes field in the first instance, the second instance indicates another mode of operation, indicated by the value carried in the Modes field in the second instance, and the third instance indicates yet another mode of operation, indicated by the value carried in the Modes field in the third instance.

The middle of FIG. 7 illustrates one example of a control field 708 that may be included within Extended Regulatory Information Element 700. As shown in FIG. 7, control field 708 may include a Modes field 712, a BSSID present field 714 (sometimes also referred to herein as BSSID presence field 714, BSSID present identifier field 714, BSSID presence identifier field 714, BSSID presence identifier 714, BSSID indicator field 714, BSSID indicator 714, or BSSID present identifier 714), a SSID present field 716 (sometimes also referred to herein as SSID presence field 716, SSID present identifier field 716, SSID presence identifier field 716, SSID presence identifier 716, SSID indicator field 716, SSID indicator 716, or SSID present identifier 716), an optional Seamless Mobility Domain Identifier (SMDID) present field 718 (sometimes also referred to herein as SMDID presence field 718, SMDID present identifier field 718, SMDID presence identifier field 718, SMDID presence identifier 718, SMDID indicator field 718, SMDID indicator 718, or SMDID present identifier 718), an enabling AP count field 720, and/or a reserved field 722.

BSSID present field 714 may be between Modes field 712 and SSID present field 716, SSID-present field 716 may be between BSSID present field 714 and SMDID present field 718, SMDID present field 718 may be between SSID present field 716 and enabling AP count field 720, and/or enabling AP count field 720 may be between SMDID present field 718 and reserved field 722. This is illustrative and non-limiting. If desired, SMDID present field 718 may be between BSSID present field 714 and SSID present field 716, SMDID present field 718 may precede BSSID present field 714, SSID present field 716 may precede BSSID present field 714, enabling AP count 720 may precede BSSID present field 714, BSSID present field 714 may be omitted, SSID present field 716 may be omitted, SMDID present field 718 may be omitted, etc. In general, fields 712-722 may be arranged in any desired order in control field 708. If desired, one or more additional fields may be appended to the beginning of control field 708, to the end of control field 708, and/or between any pair of fields 712-722 in control field 708. Modes field 712 may be a three-bit field or may have another length (e.g., between zero and three bits or higher). BSSID present field 714 may be a single-bit field or may have another length. SSID present field 716 may be a single-bit field or may have another length. SMDID present field 718 may be a single-bit field or may have another length. Enabling AP count field 720 may be a three-bit field or may have another length. Reserved field 722 may be an eight-bit field or may have another length.

The bottom of FIG. 7 illustrates one example of an observed enabling AP list field 710 that may be included within Extended Regulatory Information Element 700. As shown in FIG. 7, observed enabling AP list field 710 may include a set of M segments 732 (e.g., at least a first segment 732-1 in implementations where M > 1). Each segment 732 may be associated with and/or may identify a corresponding AP 104 that currently enables STA 106 or that has enabled STA 106 at one or more times in the past (e.g., observed enabling AP list 706 may identify M different APs 104 that enable STA 106, where M is any desired integer greater than or equal to one). The enabling APs represented in observed enabling AP list 710 may, for example, be APs 104 that STA 106 successfully received and decoded an enabling signal from at a power level above a predetermined threshold during a corresponding time period prior to the transmission time of Extended Regulatory Information Element 700.

If desired, the BSSID field may carry a MAC address (e.g., the MAC address of a GVP AP or a GVP client). Due to this generalization, the BSSID Present field may also be referred to as a “BSSID or GVP AP/Client MAC Address Present” field, or simply as a “BSSID or MAC Address Present” field. In addition, the BSSID field may sometimes also be referred to as a “BSSID or GVP AP/Client MAC Address” field.

Each segment 732 of observed enabling AP list 710 may include a channel number field 724 (e.g., a single-octet field or a field of another length), a BSSID field 726 (e.g., a six-octet field or a field of another length), a SSID field (e.g., a four-octet field or a field of another length), and/or an optional SMDID field 730 (e.g., a single-octet field or a field of another length). Channel number field 724 may include, indicate, signal, and/or identify the channel number utilized by the enabling AP associated with (identified by) the corresponding segment 732 in observed enabling AP list 710. BSSID field 726 may include, indicate, signal, and/or identify the BSSID utilized by the enabling AP associated with the corresponding segment 732 of enabling AP list 710. SSID field 728 may include, indicate, signal, and/or identify the SSID utilized by the enabling AP associated with the corresponding segment 732 of enabling AP list 710. SMDID field 730 may include, indicate, signal, and/or identify the SMDID of the enabling AP associated with the corresponding segment 732 of enabling AP list 710.

Consider one example in which STA1 of FIG. 5 transmits Extended Regulatory Information Element 700 to STA2. In this example, STA1 may include, in observed enabling AP list 710, at least a first segment 732-1 associated with (identifying) AP1, a second segment 732-2 associated with (identifying) AP3, and a third segment 732-3 associated with (identifying) AP4. The first segment 732-1 may include a channel number field 724 that includes, indicates, signals, and/or identifies the channel CH1 and a BSSID field 726 that includes, indicates, signals, and/or identifies the BSSID1 of AP1. The second segment 732-2 may include a channel number field 724 that includes, indicates, signals, and/or identifies the channel CH3 and a BSSID field 726 that includes, indicates, signals, and/or identifies the BSSID3 of AP3. The third segment 732-3 may include a channel number field 724 that includes, indicates, signals, and/or identifies the channel CH4 and a BSSID field 726 that includes, indicates, signals, and/or identifies the BSSID4 of AP4. Similarly, STA2 may transmit an Extended Regulatory Information Element 700 to STA1 over the C2C link that includes an observed enabling AP list 710 having at least a first segment 732-1 associated with its enabling AP2 and a second segment 732-2 associated with its enabling AP4.

Channel number field 724 may precede BSSID field 726, which may precede SSID field 728, which may precede SMDID field 730 in each segment 732. This is illustrative and non-limiting. If desired, BSSID field 726 may preceded channel number 724, SSID field 728 may precede BSSID field 726 or channel number field 724, SMDID field 730 may precede SSID field 728, BSSID field 726, or channel number field 724, etc. In general, fields 724-730 of segment 732 may be in any desired order. If desired, SMDID field 730 may be omitted (e.g., may be a zero-octet field). In some situations, BSSID field 726 and/or SSID field 728 may be omitted (e.g., may be zero-octet fields). If desired, one or more additional fields may be appended to the beginning of segment 732, to the end of segment 732, or between any two of fields 724, 726, 728, and 730.

Control field 708 may be used to identify, signal, and/or indicate one or more characteristics of the observed enabling AP list 710 in Extended Regulatory Information Element 700. Modes field 712 may, for example, signal or indicate the type of certification that the transmitting STA (client) has for use in its C2C link with the receiving STA (client) (e.g., to indicate the regulatory mode(s) that the transmitting STA is operating in, is capable of operating in, or is certified to operate in). The value of modes field 712 may be encoded to include, identify, signal, and/or indicate one or more regulatory (e.g., 6 GHz) modes (and thus corresponding maximum transmit power levels) that are supported and/or implemented by the transmitting STA 106. Modes field 712 may, for example, have a first value (e.g., a three-bit value encoding a value of zero) when STA 106 supports or operates in the VLP mode, may have a second value (e.g., a three-bit value encoding a value of one) when STA 106 supports or operates in a VLP and indoor-enabled AP mode, may have a third value (e.g., a three-bit value encoding a value of two) when STA 106 supports or operates in an indoor-enabled AP mode, etc. If desired, the remaining four values encodable by the three bits of Modes field 712 may be reserved (e.g., to indicate when STA 106 supports or operates in different combinations of modes, to indicate when STA 106 can operate as or with a GVP AP or GVP client, to indicate when STA 106 can operate as or with an SP-enabled AP, etc.).

BSSID present field 714 (sometimes also referred to herein as BSSID present bit 714 or BSSID presence bit 714) may indicate, identify, or signal whether BSSIDs of enabling APs are included in observed enabling AP list 710. A BSSID present field 714 containing a first value such as “0” may, for example, indicate that BSSID fields 726 are omitted from observed enabling AP list 710 (e.g., to signal to the receiving STA that the receiving STA should not expect to decode BSSID fields 726 in the observed enabling AP list 710 included later in the Extended Regulatory Information Element 700). On the other hand, a BSSID present field 714 containing a second value such as “1” may, for example, indicate that BSSID fields 726 are included in observed enabling AP list 710 (e.g., to signal to the receiving STA that the receiving STA should expect to decode BSSID fields 726 in the observed enabling AP list 710 included later in the Extended Regulatory Information Element 700).

Similarly, SSID present field 716 (sometimes also referred to herein as SSID present bit 716 or SSID presence bit 716) may indicate, identify, or signal whether SSIDs of enabling APs are included in observed enabling AP list 710. A SSID present field 716 containing a first value such as “0” may, for example, indicate that SSID fields 728 are omitted from observed enabling AP list 710 (e.g., to signal to the receiving STA that the receiving STA should not expect to decode SSID fields 728 in the observed enabling AP list 710 included later in the Extended Regulatory Information Element 700). On the other hand, a SSID present field 716 containing a second value such as “1” may, for example, indicate that SSID fields 728 are included in observed enabling AP list 710 (e.g., to signal to the receiving STA that the receiving STA should expect to decode SSID fields 728 in the observed enabling AP list 710 included later in the extended regulatory info element 700). SSID fields 728 may be omitted and SSID present field 716 may be set to the first value when the enabling APs 104 identified by observed enabling AP list 710 are not associated with and/or do not implement a corresponding SSID, for example. At a high level, SSID fields 728 and the corresponding SSID present field 716 may serve to differentiate between networks that have different SSIDs and that can each include multiple APs.

In the SSID field, the full SSID may be present or, alternatively, a Short-SSID may be present. If the full SSID is carried by the SSID field, then this field may be an SSID element as defined in the 802.11 specification (e.g., per the IEEE 802.11 specification, the SSID Element includes Element ID, Length and SSID fields). On the other hand, the Short-SSID has a fixed length of 4 octets, whereas the SSID has a variable length. Therefore, the length of SSID field 728 may be zero, four, or a variable number of octets. If the full SSID is included in the SSID field, the length of the SSID needs to be known by a receiving client, thus its length is provided separately within the SSID element. Alternatively, the length of the SSID may be inferred from length field 704 (e.g., given all other fields have a known length, the length of the SSID can be inferred).

Similarly, SMDID present field 718 (sometimes also referred to herein as SMDID present bit 718 or SMDID presence bit 718) may indicate, identify, or signal whether SMDIDs of enabling APs are included in observed enabling AP list 710. An SMDID present field 718 containing a first value such as “0” may, for example, indicate that SMDID fields 730 are omitted from observed enabling AP list 710 (e.g., to signal to the receiving STA that the receiving STA should not expect to decode SMDID fields 730 in the observed enabling AP list 710 included later in the Extended Regulatory Information Element 700). On the other hand, an SMDID present field 718 containing a second value such as “1” may, for example, indicate that SMDID fields 730 are included in observed enabling AP list 710 (e.g., to signal to the receiving STA that the receiving STA should expect to decode SMDID fields 730 in the observed enabling AP list 710 included later in the Extended Regulatory Information Element 700).

Enabling AP count field 720 may indicate, signal, include, and/or identify the number of observed enabling APs identified or included within observed enabling AP list 710. Put differently, enabling AP count field 720 may indicate the size of observed enabling AP list 710 or the number M of segments 732 included in observed enabling AP list 710. The receiving STA may, for example, use this information to know how many segments 732 to expect to decode in the observed enabling AP list 710 included later in the Extended Regulatory Information Element 700.

SMD, as indicated using SMDID field 730, is an 802.11bn concept where a more advanced roaming occurs between APs (or multi-link device (MLD) APs) that belong to the same Seamless Mobility Domain. Seamless roaming is a mechanism for a non-MLD to transition from its current AP MLD to a target AP MLD that minimizes the time during which connectivity between the non-AP MLD and the DS is lost. By using this mechanism, the non-AP MLD remains in State 4 of association during the transition while preserving the context for data transmission for a seamless experience.

Observed enabling AP list 710 may carry as many (extended) regulatory fields as the enabling AP count field 720 in control field 708 indicates. Enabling AP count field 720 may be omitted from control field 708 if desired. In implementations where an enabling AP has multiple BSSIDs, the STA may use BSSID field 726 to indicate the transmitted BSSID of the enabling AP. In cases where co-located APs operate (e.g., the same physical AP operates multiple Basic Service Sets), a STA may receive multiple beacons from the same AP and is enabled by all of the corresponding virtual APs. The STA may recognize these APs as co-located APs. If desired, the STA may report all of the BSSIDs of the AP in BSSID field 726 (e.g., within a single segment 732 or across multiple segments 732) to increase the chance of having a common enabling AP with its peer devices (e.g., the STA receiving the transmitted Extended Regulatory Information Element 700). If desired, a STA may omit BSSID fields 726 and SSID fields 728 from observed AP enabling list 710 when broadcasting its Extended Regulatory Information Element 700. However, when the STA exchanges frames with a peer STA over a C2C link, the STA may include these fields in a protected action frame if desired.

Element identifier field 702 of Extended Regulatory Information Element 700 may, if desired, signal, indicate, or identify that Extended Regulatory Information Element 700 is an Extended Regulatory Information Element instead of a non-Extended Regulatory Info Element (e.g., an existing regulatory info element that signals, indicates, or identifies an infra-BSS mode). If desired (e.g., while processing operation 606 of FIG. 6), STA1 may transmit, to STA2, a request for the Extended Regulatory Information Element 700 of STA2 (e.g., in a probe request). If desired, STA1 may include, in the probe request, its own Extended Regulatory Information Element 700 (e.g., with an element identifier 702 identifying that the probe request includes Extended Regulatory Information Element 700 as opposed to a non-extended regulatory info element). In implementations where Extended Regulatory Information Element 700 is transmitted in a beacon frame, some of the optional fields may not be present (e.g., to help preserve privacy of the transmitting STA).

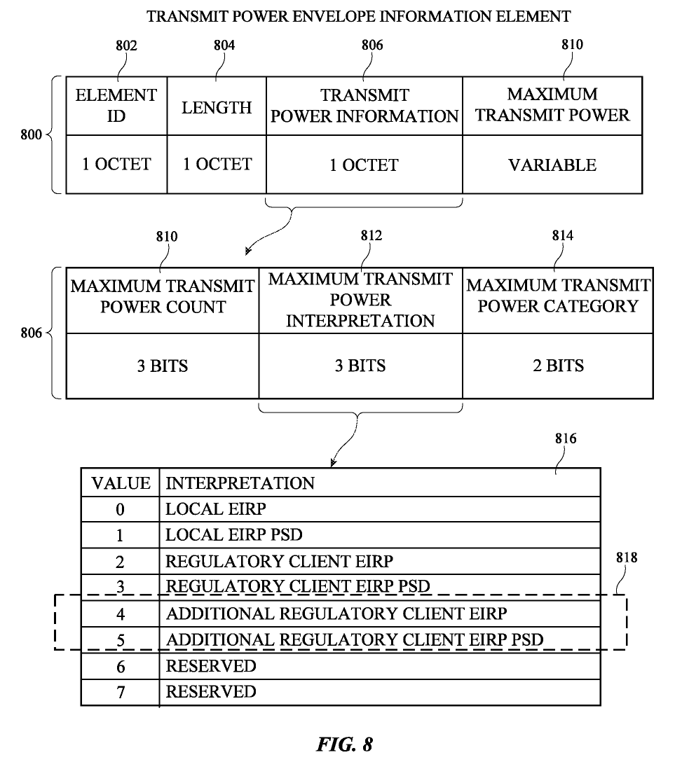

If desired, in addition to transmitted Extended Regulatory Information Element 700, STA 106 may also transmit one or more Transmit Power Envelope (TPE) Information Elements (IEs) to a receiving STA over a corresponding C2C link (e.g., while processing operation 608 of FIG. 6). FIG. 8 shows one example of an illustrative TPE IE 800 that STA1 may transmit to STA2 over a C2C link. STA 106 may transmit TPE IE 800 in the same frame as Extended Regulatory Information Element 700 or in a different frame (e.g., beacon frame, a probe request frame, a probe response frame, an association frame, a reassociation frame, a neighbor awareness networking (NAN) discovery beacon frame, a NAN synchronization frame, etc.).

As shown in FIG. 8, TPE IE 800 may include an element identifier (ID) 802, a length field 804, a transmit power information field 806, and a maximum transmit power field 808. Transmit power information field 806 may include a maximum transmit power count field 810, a maximum transmit power interpretation field 812, and a maximum transmit power category field 814. These fields may be in other orders, one or more of these fields may be omitted, and/or one or more additional fields may be included in TPE IE 800.

Maximum transmit power interpretation field 812 may indicate how the other information included in TPE IE 800 (e.g., fields 808, 710, and/or 814) is to be interpreted by a receiving device. Table 816 lists how different values of maximum transmit power interpretation field 812 may encode different information (interpretations) for TPE IE. As shown in table 816, a value of zero may indicate that TPE IE 800 includes, signals, identifies, or indicates a local effective isotropic radiated power (EIRP), a value of one may indicate that TPE IE 800 includes, signals, identifies, or indicates an EIRP power spectral density (PSD), a value of two may indicate that TPE IE 800 includes, signals, identifies, or indicates a regulatory client EIRP, a value of three may indicate that TPE IE 800 includes, signals, identifies, or indicates a regulatory client EIRP PSD, a value of four may indicate that TPE IE 800 includes, signals, identifies, or indicates an additional regulatory client EIRP, a value of five may indicate that TPE IE 800 includes, signals, identifies, or indicates an additional regulatory client EIRP PSD, and values of six and seven may be reserved. In this example, the transmitting STA may, if desired, use values 818 of maximum transmit power interpretation field 812 (e.g., values of four and/or five) to indicate that TPE IE 800 includes, signals, identifies, or indicates one or more TPEs associated with the regulatory mode(s) identified in Modes field 712 of a corresponding Extended Regulatory Information Element 700 (FIG. 7) transmitted by the STA (e.g., LPI, SP, and/or composite AP enabled C2C maximum transmit power levels or backoffs, a VLP maximum transmit power level, other P2P devices maximum transmit power level, etc.).

In practice, some regulators may require peer STAs to be enabled by the same AP when performing C2C communications with each other. This requirement may place a burden on peer STAs to find common enabling indoor APs. The STAs may, for example, need to scan the entire 6 GHz band to find common (shared) enabling APs. The transmission of Extended Regulatory Information Elements 700 between STAs may, for example, serve to indicate to the receiving STA which channel(s) (e.g., beacon(s)) of enabling AP(s) have already been detected (observed) by the transmitting STA. After receiving an Extended Regulatory Information Element 700 indicating the channel(s), the receiving STA need only scan over those indicated channel(s) to determine whether there is an enabling AP transmitting in the indicated channel(s) and if so, may then verify that the BSSID of the AP matches the corresponding BSSID indicated by the received Extended Regulatory Information Element 700. This may serve to greatly increase the efficiency with which STAs that are required to be enabled by the same AP are able to communicate with each other and with the network. If desired, BSS color (e.g., as obtained from a beacon frame) may also be reported for each observed enabling AP (e.g., may be indicated by a BSS color field included in a corresponding segment 732 of observed AP enabling 710 in Extended Regulatory Information Element 700). The BSS color field may, for example, be included within and/or appended to the channel number field 724 of the enabling AP (FIG. 7).

For example, in deployment 500 of FIG. 5, STA1 may use Extended Regulatory Information Element 700 to advertise that STA1 has been enabled by AP3, in channel CH3, and to advertise that STA1 has been enabled by AP4, in channel CH4. Once STA2 has received Extended Regulatory Information Element 700 from STA1, STA2 does not need to scan over all channels of the 6 GHz spectrum to find its own enabling APs. Instead, STA2 may scan only over channels CH3 and CH4 (e.g., as identified in the received Extended Regulatory Information Element 700). STA2 may detect that AP4 is an enabling AP from its scan of channel CH4 but does not detect that AP3 is an enabling AP from its scan of channel CH3 in the example of FIG. 5. STA2 may, for example, perform these scans while processing operation 610 of FIG. 6. This process is substantially faster than scanning the entire 6 GHz spectrum.

In some situations, for C2C communications, a regulator may impose a regulatory requirement that a client periodically verify that it is enabled by an AP. For example, some jurisdictions may require that a client has to verify, every four seconds, that the client is enabled by the AP that has utilized its enablement for C2C communication. If desired, STA 106 may list its enabling APs (e.g., in observed enabling AP list 710 of Extended Regulatory Information Element 700) in a decreasing order of the signal strength of the enabling signal received from the enabling APs. For example, STA 106 may list enabling APs that transmitted enabling signals that were measured by STA 106 at higher signal strengths (e.g., higher received power levels) earlier in observed AP enabling list 710 (e.g., in earlier or preceding segments 732 of FIG. 3) than enabling APs that transmitted enabling signals that were measured by STA 106 at lower signal strengths (e.g., lower received power levels).

Consider, for example, deployment 500 of FIG. 5. In this example, STA1 may measure an enabling signal transmitted by AP1 at a signal level (e.g., with a received signal strength indicator (RSSI) of -60 dBm, may measure an enabling signal transmitted by AP3 at a signal level (e.g., RSSI) of -75 dBm, and may measure an enabling signal transmitted by AP4 at a signal level (e.g., RSSI) of -65 dBm. In this example, STA1 may include, in the observed enabling AP list 710 of the Extended Regulatory Information Element 700 transmitted to STA2, the segment 732 associated with AP1 first in observed enabling AP list 710, followed by the segment 732 associated with AP4, followed by the segment 732 associated with AP3. On the other hand, if STA2 measures an enabling signal transmitted by AP4 at a signal level (e.g., RSSI) of -70 dBm and measures an enabling signal transmitted by AP2 at a signal level (e.g., RSSI) of -65 dBm, STA2 may include, in the observed enabling AP list 710 of the Extended Regulatory Information Element 700 transmitted to STA1, the segment 732 associated with AP2 first in observed enabling AP list 710, followed by the segment 732 associated with AP4. This type of priority-based listing of enabling APs may, for example, serve to increase the robustness with which C2C communications and/or AP-client communications are performed by STA1 and STA2.

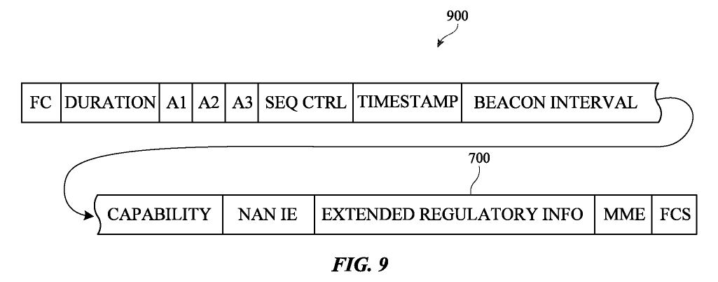

FIG. 9 is a diagram of an illustrative NAN frame 900 that may be used to convey Extended Regulatory Information Element 700 of FIG. 7 (e.g., while processing operation 604 of FIG. 6, such as in implementations where the C2C link between STAs 106 is a NANC2C link). NAN is sometimes also referred to as Wi-Fi Aware. NAN frame 900 may be, for example, a NAN discovery beacon frame or a NAN synchronization frame. When NAN frame 900 is a NAN discovery beacon frame, some optional fields may be omitted from NAN frame 900 to preserve privacy of the transmitting STA. In the example of FIG. 9, Extended Regulatory Information Element 700 is inserted into NAN frame 900 between a NAN IE field and a mobility management entity (MME) field. This is illustrative and non-limiting. If desired, Extended Regulatory Information Element 700 may be between any two fields of the fields of NAN frame 900.

In implementations where STAs 106 operate under a GVP mode, the STAs may communicate with one or more GVP APs having geofencing capabilities. The GVP APs may have access to geofence exclusion zones or may perform geofencing calculations locally. If desired, a National Regulatory Authority Incumbent database may be used to calculate exclusion zones at a GVP AP locally or on the cloud. Exclusion zones may be calculated for each channel or frequency. Exclusion zones may be calculated for a variable range of power levels. Channel Model and other parameters may be based on those of an AFC system and SP mode. A GVP client may not have access to geofencing capabilities. A GVP client may operate under control of a GVP AP. A GVP client may use frequencies that are used by the GVP AP. A GVP client may use power levels as advertised by the GVP AP. GVP clients under control of the same GVP AP may communicate directly. A GVP mode may be used for different P2P applications including Soft-AP. This is illustrative and non-limiting.

FIG. 10 shows an illustrative non-limiting deployment for communication system 108 in which the system includes an Infra-BSS group or network having a corresponding AP as well as a P2P group (e.g., in any of the methods or systems described above). As shown in FIG. 10, the Infra-BSS group may include STA1, STA2, and STA3. The P2P group may include STA3, STA4, and STA5. The dashed line between the AP and STA3 indicates that STA3 is enabled by the AP. The solid lines in FIG. 10 indicate AP-STA links (associations) or established P2P links. As shown in FIG. 10, some STAs such as STA3 may communicate or listen to another network (e.g., a P2P network/group) while communicating with their own network (e.g., the Infra-BSS). A STA may communicate within its P2P group and may also communicate in the Infra-BSS, or may listen to the AP without communicating with the AP.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.” The term “when” also implies at least some concurrency (e.g., event A occurring “when” event B occurs means that at least some of event A is concurrent with at least some of event B).

STAs 106 and APs 102/104 (FIG. 1) may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-9 may be performed by the components of a STA and/or AP using software, firmware, and/or hardware (e.g., dedicated circuitry or hardware). Software code for performing these operations may be stored on non-transitory computer readable storage media (e.g., tangible computer readable storage media) stored on one or more of the components of the STA and/or AP. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the STA and/or AP. The processing circuitry may include microprocessors, central processing units (CPUs), application-specific integrated circuits with processing circuitry, or other processing circuitry.

For one or more aspects, at least one of the components set forth in one or more of the preceding figures may be configured to perform one or more operations, techniques, processes, or methods as set forth in the example section below. For example, circuitry associated with an electronic device, authentication server, one or more processors, etc. as described above in connection with one or more of the preceding figures may be configured to operate in accordance with one or more of the examples set forth below in the example section.

### Examples

In the following sections, further exemplary aspects are provided.

Example 1 includes a method of operating a first station (STA). The method includes transmitting, to the second STA via a peer-to-peer (P2P) link, a frame that includes a regulatory information element, wherein the regulatory information element includes a list indicating one or more access points (APs) from which the first STA decoded signals of at least a threshold power level.

Example 2 includes the method of example 1 or some other example or combination of examples herein, wherein the regulatory information element comprises a control field that indicates a regulatory mode supported by the first STA for communication over the P2P link, the regulatory mode being associated with a corresponding maximum transmit power level.

Example 3 includes the method of any of examples 1 or 2 or some other example or combination of examples herein, wherein the regulatory mode comprises a very low power (VLP) mode, a C2C mode, or a geofenced variable power (GVP) mode.

Example 4 includes the method of any of examples 1-3 or some other example or combination of examples herein, wherein the list comprises one or more channel number fields that indicate one or more channels utilized by the one or more APs.

Example 5 includes the method of any of examples 1-4 or some other example or combination of examples herein, wherein the list further comprises one or more basic service set identifier (BSSID) fields that indicate one or more BSSIDs utilized by the one or more APs.

Example 6 includes the method of any of examples 1-5 or some other example or combination of examples herein, wherein the list further comprises one or more service set identifier (SSID) fields that indicate one or more SSIDs of the one or more APs, the one or more SSIDs being different than the one or more BSSIDs.

Example 7 includes the method of any of examples 1-6 or some other example or combination of examples herein, wherein the list further comprises one or more Seamless Mobility Domain Identifier (SMDID) fields that indicate one or more SMDIDs of the one or more APs.

Example 8 includes the method of any of examples 1-7 or some other example or combination of examples herein, further comprising: receiving, from a first AP, a first signal at a first power level greater than the threshold; and receiving, from a second AP, a second signal at a second power level greater than the threshold, wherein the list further comprises a first segment that indicates the first AP and a second segment that indicates the second AP.

Example 9 includes the method of any of examples 1-8 or some other example or combination of examples herein, wherein the second power level is higher than the first power level and wherein the second segment precedes the first segment in the list.

Example 10 includes the method of any of examples 1-9 or some other example or combination of examples herein, wherein the regulatory information element further comprises a control field preceding the list and wherein the control field comprises a modes field that indicates a regulatory mode supported by the first STA.

Example 11 includes the method of any of examples 1-10 or some other example or combination of examples herein, wherein the control field further comprises a basic service set identifier (BSSID) present bit that indicates whether the list includes a BSSID of the one or more APs.

Example 12 includes the method of any of examples 1-11 or some other example or combination of examples herein, wherein the control field further comprises a service set identifier (SSID) present bit that indicates whether the list includes an SSID of the one or more APs, the SSID being different than the BSSID.

Example 13 includes the method of any of examples 1-10 or some other example or combination of examples herein, wherein the control field comprises a Seamless Mobility Domain Identifier (SMDID) present bit that indicates whether the list includes an SMDID of the one or more APs.

Example 14 includes the method of any of examples 1-13 or some other example or combination of examples herein, wherein the control field comprises a count value that indicates a number of APs indicated by the list.

Example 15 includes the method of any of examples 1-14 or some other example or combination of examples herein, wherein the frame comprises a Beacon frame, a Probe Request frame, a Probe Response frame, an Association Request frame, an Association Response frame, a Reassociation Request frame, a Reassociation Response frame, a Neighbor Awareness Networking (NAN) Discovery Beacon frame, or a NAN synchronization frame.

Example 16 includes the method of any of examples 1-15 or some other example or combination of examples herein, further comprising: receiving, from the second STA via the P2P link, an additional frame that includes an additional regulatory information element, wherein the additional regulatory information element comprises a list indicating one or more additional APs from which the second STA decoded additional signals of at least the threshold power level.

Example 17 includes a method of operating a first station (STA). The method includes establishing a peer-to-peer (P2P) link with a second STA. The method includes receiving, from the second STA via the P2P link, a frame that includes a regulatory information element, wherein the regulatory information element includes a list that indicates one or more access points (APs) from which the second STA decoded signals of at least a threshold power level.

Example 18 includes the method of example 17 or some other example or combination of examples herein, wherein the list comprises a respective channel number and a respective basic service set identifier (BSSID) of the one or more APs.

Example 19 includes the method of any of examples 17 or 18 or some other example or combination of examples herein, wherein the regulatory information element comprises a control field, the control field comprising: a modes field that identifies a P2P regulatory mode supported by the second STA; a BSSID present bit that indicates that the list includes the respective BSSIDs of the one or more APs; and a count field that indicates a number of APs indicated by the list.

Example 20 includes a method of operating a radio. The method includes measuring a first power level of a first signal transmitted by a first access point (AP), wherein the first power level exceeds a threshold. The method includes measuring a second power level of a second signal transmitted by a second access point (AP), wherein the second power level exceeds the threshold. The method includes transmitting a frame, wherein the frame includes a regulatory information element and the regulatory information element comprises a control field that indicates a client-to-client (C2C) regulatory mode supported by the radio, and a list that indicates a first channel number associated with the first signal and that indicates a second channel number associated with the second signal.

Example 21 includes a method where a Number of Modes field, which appears between Element ID Extension 707 and Control field 708, indicates a value greater than 1, which means that there would a multiple instances of Control field 708 and Observed Enabling AP List field 710, each instance follows the previous instance. In each of the instances of Control field 708 and Observed Enabling AP List field 710, the information contained therein may be different from another instance. This representation indicates multiple modes of operation where: the first instance indicates one of mode of operation, indicated by the value carried in the Modes field in the first instance, the second instance indicates another mode of operation, indicated by the value carried in the Modes field in the second instance, and the third instance indicates yet another mode of operation, indicated by the value carried in the Modes field in the third instance, and so on.

Example 22 may include an apparatus comprising means to perform one or more elements of a method described in or related to any of examples 1-21 or any combination thereof, or any other method or process described herein.

Example 23 may include one or more non-transitory computer-readable media comprising instructions to cause an electronic device, upon execution of the instructions by one or more processors of the electronic device, to perform one or more elements of a method described in or related to any of examples 1-21 or any combination thereof, or any other method or process described herein.

Example 24 may include an apparatus comprising logic, modules, or circuitry to perform one or more elements of a method described in or related to any of examples 1-21 or any combination thereof, or any other method or process described herein.

Example 25 may include a method, technique, or process as described in or related to any of examples 1-21 or any combination thereof, or portions or parts thereof.

Example 26 may include an apparatus comprising: one or more processors and one or more non-transitory computer-readable storage media comprising instructions that, when executed by the one or more processors, cause the one or more processors to perform the method, techniques, or process as described in or related to any of examples 1-20, or any combination thereof, or portions thereof.

Example 27 may include a signal as described in or related to any of examples 1-21, or any combination thereof, or portions or parts thereof.

Example 28 may include a datagram, information element, packet, frame, segment, PDU, or message as described in or related to any of examples 1-20, or any combination thereof, or portions or parts thereof, or otherwise described in the present disclosure.

Example 29 may include a signal encoded with data as described in or related to any of examples 1-21, or any combination thereof, or portions or parts thereof, or otherwise described in the present disclosure.

Example 30 may include a signal encoded with a datagram, IE, packet, frame, segment, PDU, or message as described in or related to any of examples 1-21, or any combination thereof, or portions or parts thereof, or otherwise described in the present disclosure.

Example 31 may include an electromagnetic signal carrying computer-readable instructions, wherein execution of the computer-readable instructions by one or more processors is to cause the one or more processors to perform the method, techniques, or process as described in or related to any of examples 1-21, or any combination thereof, or portions thereof.

Example 32 may include a computer program comprising instructions, wherein execution of the program by a processing element is to cause the processing element to carry out the method, techniques, or process as described in or related to any of examples 1-21, or any combination thereof, or portions thereof.

Example 33 may include a signal in a wireless network as shown and described herein.

Example 34 may include a method of communicating in a wireless network as shown and described herein.

Example 35 may include a system for providing wireless communication as shown and described herein.

Example 36 may include a device for providing wireless communication as shown and described herein.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed.

What is claimed is:

1. A method of operating a first station (STA), the method comprising:
transmitting, to a second STA via a peer-to-peer (P2P) link, a frame that includes a regulatory information element, wherein the regulatory information element comprises a list indicating one or more access points (APs) from which the first STA decoded signals of at least a threshold power level.

2. The method of claim 1, wherein the regulatory information element comprises a control field that indicates a regulatory mode supported by the first STA for communication over the P2P link, the regulatory mode being associated with a corresponding maximum transmit power level.

3. The method of claim 2, wherein the regulatory mode comprises a very low power (VLP) mode, a C2C mode, or a geofenced variable power (GVP) mode.

4. The method of claim 1, wherein the list comprises one or more channel number fields that indicate one or more channels utilized by the one or more APs.

5. The method of claim 4, wherein the list further comprises one or more basic service set identifier (BSSID) fields that indicate one or more BSSIDs utilized by the one or more APs.

6. The method of claim 5, wherein the list further comprises one or more service set identifier (SSID) fields that indicate one or more SSIDs of the one or more APs, the one or more SSIDs being different than the one or more BSSIDs.

7. The method of claim 4, wherein the list further comprises one or more Seamless Mobility Domain Identifier (SMDID) fields that indicate one or more SMDIDs of the one or more APs.

8. The method of claim 4, further comprising:
receiving, from a first AP, a first signal at a first power level greater than the threshold; and
receiving, from a second AP, a second signal at a second power level greater than the threshold, wherein the list further comprises a first segment that indicates the first AP and a second segment that indicates the second AP.

9. The method of claim 8, wherein the second power level is higher than the first power level and wherein the second segment precedes the first segment in the list.

10. The method of claim 4, wherein the regulatory information element further comprises a control field preceding the list and wherein the control field comprises a Modes field that indicates a regulatory mode supported by the first STA.

11. The method of claim 10, wherein the control field further comprises a basic service set identifier (BSSID) present bit that indicates whether the list includes a BSSID of the one or more APs.

12. The method of claim 11, wherein the control field further comprises a service set identifier (SSID) present bit that indicates whether the list includes an SSID of the one or more APs, the SSID being different than the BSSID.

13. The method of claim 10, wherein the control field comprises a Seamless Mobility Domain Identifier (SMDID) present bit that indicates whether the list includes an SMDID of the one or more APs.

14. The method of claim 10, wherein the control field comprises a count value that indicates a number of APs indicated by the list.

15. The method of claim 1, wherein the frame comprises a Beacon frame, a Probe request frame, a Probe response frame, an Association Request frame, an Association Response frame, a Reassociation Request frame, a Reassociation Response frame, a Neighbor Awareness Networking (NAN) Discovery Beacon frame, or a NAN Synchronization frame.

16. The method of claim 1, further comprising:
receiving, from the second STA via the P2P link, an additional frame that includes an additional regulatory information element, wherein the additional regulatory information element comprises a list indicating one or more additional APs from which the second STA decoded additional signals of at least the threshold power level.

17. A method of operating a first station (STA), the method comprising:
establishing a peer-to-peer (P2P) link with a second STA; and
receiving, from the second STA via the P2P link, a frame that includes a regulatory information element, wherein the regulatory information element includes a list that indicates one or more access points (APs) from which the second STA decoded signals of at least a threshold power level.

18. The method of claim 17, wherein the list comprises a respective channel number and a respective basic service set identifier (BSSID) of the one or more APs.

19. The method of claim 17, wherein the regulatory information element comprises a control field, the control field comprising:
a Modes field that identifies a P2P regulatory mode supported by the second STA;
a BSSID present bit that indicates that the list includes the respective BSSIDs of the one or more APs; and
a count field that indicates a number of APs indicated by the list.

20. A method of operating a radio, the method comprising:
measuring a first power level of a first signal transmitted by a first access point (AP), wherein the first power level exceeds a threshold;
measuring a second power level of a second signal transmitted by a second access point (AP), wherein the second power level exceeds the threshold; and
transmitting a frame, wherein the frame includes a regulatory information element and the regulatory information element comprises
a control field that indicates a peer-to-peer (P2P) regulatory mode supported by the radio, and
a list that indicates a first channel number associated with the first signal and that indicates a second channel number associated with the second signal.
